(19) United States
(12) Patent Application Publication
(10) Pub. No.: US 2004/0059654 A1
(43) Pub. Date: Mar. 25, 2004

(54) Method and system for processing and display of variables in a user generated network diagram representing a balanced system

(76) Inventors: Hans Schroder, Helsinge (DK); William Rolle, Aaborg (DK)

Correspondence Address: MERCHANT & GOULD PC, P.O. BOX 2903, MINNEAPOLIS, MN, 55402-0903, US

(21) Appl. No.: 10/332,445

(22) PCT Filed: Jul. 6, 2001
(86) PCT No.: PCT/DK01/00474

(30) Foreign Application Priority Data
Jul. 7, 2000 (DK) PA 2000 01070

(51) Int. Cl. G06F 17/60

(52) U.S. Cl. 705/35

(57) ABSTRACT

A computer system and a computer implemented method for processing and display of variables in a user generated network diagram representing a balanced system, wherein the variables represent stocks and flows of resources and key ratios being ratios of linear combinations of flows and/or stocks of resources. A user interface is used for graphically creating a balanced system in the form of a network diagram having: one or more nodes, at least one input flow from a giving system into a node, at least one output flow from a node into a receiving system, and/or one or more flows between nodes.

### FIELD OF THE INVENTION

The invention concerns a method and a system for accounting and management of financial and environmental resources.

### DESCRIPTION OF THE RELEVANT PRIOR ART

So far, computer experts and accountants have paid little heed to the close relationship between accounting and mathematics. Although mathematicians and accounting academics introduced the computerised accounting matrix about 40 years ago, modern accounting software, and the teaching of accounting, is still based on the debit-credit method dating back to the dawn of civilisation. At the advent of the mainframe computer, the American economist W. Leontief applied computerised matrix algebra, input-output analysis, in his/renowned work “The Structure of the American Economy” (1951). Inspired by Leontief's work, the Canadian economist Richard Mattessich extended tended the matrix notation as a basic form of double classification to other accounting systems. Mattessich demonstrated the considerable advantages of the mathematical approach to accounting, and essentially extended the input-out method.

At the advent of the Personal Computer, Daniel Bricklin and Bob Frankston introduced the first PC-based electronic spreadsheet (VisiCalc) anticipated by Mattessich's pioneering work on the mainframe. Although its first application concerned accounting and financial simulation, the computerised matrix approach did not catch on. Even today, software systems for accounting and financial management are based on the ancient debit-credit method and do not exploit the considerable advantages of the input-output method.

In the field of ecology, biologists and engineers apply the input-output method on a routine basis in their attempts to account for flows and stocks of energy and materials in natural systems. Ecologists and engineers have for a long time exploited the advantages of the computerised input-output put-output method. Some have further improved it by visualising the accounting matrix as a network (a directed graph) of flows and stocks.

The PC-based electronic spreadsheet has advanced accounting, economic and ecological modelling to a great extent, but it remains to abandon the debit-credit method and instead apply the input-output method. It further remains to unify financial and environm ntal accounting (energy/materials accounting), and to establish an account processing system, which economists, accountants, cologists, engineers and students can readily understand and apply on a daily basis.

What is needed is a processing system that lets us process accounts in any conserved currency like a word processing system lets us process words in any language.

### SUMMARY OF THE INVENTION

The present invention is the prototype of such a processing system.

According to a first aspect of the present invention there is provided a computer system for processing and display of variables in a user generated network diagram representing a balanced system, said variables representing stocks and flows of resources and key ratios being ratios of linear combinations of flows and/or stocks of resources, said system comprising:

a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources into or from a subsystem,

means for assigning all output flows of resources from each subsystem as dependent variables,

a user interface for assigning the stock of resources contained in each subsystem as a dependent or an independent variable,

means for assigning all flows of resources from the giving system into a node in the network as independent variables,

means for generating and/or user-defining, for each subsystem, a number of key ratio equations, each said key ratio equation consisting of a key ratio being an independent variable set equal to a fraction, a ratio, with a linear combination of flows and/or stocks in the numerator and another linear combination of flows and/or stocks in the denominator, said number of key ratio quations being equal to the number of dependent variables assigned to said subsystem minus one,

a user interface for entering numerical values of some or all of the independent variables, and

means for calculating numerical values of some or all of the dependent variables based on values of the independent variables.

It is preferred that the system is adapted for displaying entered values of independent variables and calculated values of dependent variables.

In a preferred embodiment the means for calculating the values of the dependent variables is adapted for generating, for each subsystem, a balance equation, said balance equation stating the balance: flows of resources into the subsystem minus flows of resources out of the subsystem equals the stock of resources contained in the subsystem. The means for calculating the dependent variables may be adapted for performing said calculation based on balance equations and key ratio equations. Here, the means for calculating the dependent variables may be adapted for performing said calculation based on a set of n+m simultaneous linear equations where n is equal to the number of subsystems in the network, and thereby to the number of balance equations, and m is equal to the sum of the number of key ratio equations attached to each subsystem.

In order to obtain a sufficient number of equations for calculating the dependent variables, the means for generating the key ratio equations may be adapted for generating m default key ratio equations, where m is equal to the sum of the number of key ratio equations attached to each subsystem.

The key ratio equations may be generated as default equations by the computer processing system or may be entered by a user. Thus, the means for generating and/or defining the key ratios may comprise a user interface for entering user-defined key ratios. In a preferred embodiment the means for generating a default key ratio equation is adapted for generating key ratio equations having a numerator given by a single output flow from the corresponding subsystem. Here, the means for generating a default key ratio equation may be adapted for generating key ratio equations so that all generated key ratio equations have a numerator given by a single output flow from the corresponding subsystem.

The means for generating a default key ratio equation may also be adapted for generating key ratio equations as output coefficients having the above mentioned numerator and a denominator given by the total flow output from the corresponding subsystem plus the stock of the corresponding subsystem. Alternatively, the means for generating a default k y ratio quation may be adapted for generating key ratio quations having a denominator given by th total flow input to the corresponding subsystem. It is preferred that the computer processing system is adapted for displaying th syst m-generated or the user-defined key ratios.

In order to identify the flows and stocks of the balanced system, the computer processing system may be adapted for attaching a tag, a variable identifier, to each node and each flow, said calculated and/or entered values of flows and stocks being displayed adjacent to the corresponding tag. Preferably, the computer processing system of the invention is adapted for identifying the stock contained in each subsystem by a single-indexed tag. The system of the invention may also be adapted to link each node to a dialog box allowing a user to assign the stock to be a dependent or an independent variable. It is also preferred that the system of the invention is adapted for identifying each flow by a double-indexed tag holding information of the system or subsystem of origin of the flow and of the receiving system or subsystem. Also here, the system of the invention may be adapted to link flows to a dialog box allowing a user to assign a flow to be a dependent or independent variable. The means for generating the key ratio equations may use said identifiers, thereby representing flows identified by said double-indexed flow identifiers, and stocks identified by said single-indexed stock identifiers.

When graphically creating a network diagram, the system may indicate for each flow the direction of the flow of resources. Also, the system may display each node in the form of a rectangle. When displaying the variables, the system of the invention may display the values of some of the variables, values of a selected number of the variables, or all entered values of independent variables and all calculated values of dependent variables. If a variable is not known, i.e. the value has not been entered or the system is not capable of calculating the value due to for example missing values of independent variables, the system may display the value of unknown independent and dependent variables as unknown to the user.

In order to obtain the minimum required or a sufficient number of key ratio equations, the means for generating key ratio equations may be adapted for generating, for each subsystem being a flow account in which the stock is an independent variable, a default key ratio equation for each outgoing flow from the subsystem minus one. The means for generating the key ratio equations may further be adapted for generating, for each subsystem being a stock account in which the stock is a dependent variable, a default key ratio equation for each outgoing flow.

According to an embodiment of the invention the means for calculating the values of the dependent variables may be adapted to arrange the (n+m) linear equations in a form corresponding to a matrix equation with the values of the matrix elements being derived from the set of (n+m) linear equations and the ntered values of independent variables. Here, the means for calculating the values of th d p ndent variables may be adapted to arrange the (n+m) linear equations in a form corresponding to a matrix equation MA[i,j]*X=MBM[i], where X is a solution vector comprising the d pendent variables, MB[i] is a vector with a single column of functions of independent variables, and MA[i,j] is a quadratic coefficient matrix, wherein the values of the matrix lements are derived from the set of (n+m) linear equations and wherein the elements of MB are derived from the entered values of the independent variables. When determining the matrix elements, the means for calculating the values of the dependent variables may be adapted to derive a single row of the matrix elements from a key ratio equation. Also, the means may be adapted to derive a single row of the matrix elements from a balance equation. Here it should be understood that the means for calculating the values of the dependent variables preferably is adapted to calculate said values by solving the matrix equation.

The above described embodiments of systems of the present invention may be described as operating in a so-called forecast, mode of operation. Thus, the present invention also provides a computer processing system operating in a so-called hindcast mode of operation. Preferably, the computer system may be adapted to alternate between hindcast and forecast.

However, before describing a system operating in the hindcast, it should be mentioned that the first aspect of the invention also relates to a computer implemented method of operation. Thus, according to the first aspect of the invention there is provided a computer implemented method for processing and display of variables in a user generated network diagram representing a balanced system, said variables representing stocks and flows of resources and key ratios being ratios of linear combinations of flows and/or stocks of resources, said method comprising:

graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,

for each subsystem assigning all output flows of resources from said subsystem as dependent variables,

for each subsystem assigning the stock of resources as a dependent or an independent variable,

assigning all flows of resources from the giving system into a node as an independent variabl ,

for ach subsystem generating and/or user-defining a number of k y ratio equations, each said key ratio equation consisting of a key ratio being an indep ndent variable set equal to a fraction or a ratio with a linear combination of flows and/or stocks in th numerator and another linear combination of flows and/or stocks in the denominator, said number of key ratio equations being equal to the number of dependent variables assigned to said subsystem minus one,

entering and storing data representing values of some or all of the independent variables, and

calculating values of some or all of the dependent variables based on values of independent variables.

Preferably, the method further comprises displaying entered values of independent variables and calculated values of dependent variables.

According to a preferred embodiment of present invention each subsystem has a corresponding balance equation, said balance equation stating the balance: flows of resources into the subsystem minus flows of resources out of the subsystem equals the stock of resources contained in the subsystem. Thus, the calculation of the values of the dependent variables may be based on the balance equations and the key ratio equations. Here, the calculation of the values of the dependent variables may be based on a set of (n+m) simultaneous linear equations, where n is equal to the number of subsystems in the network, and thereby to the number of balance equations, and m is equal to the sum of the number of key ratio equations attached to each subsystem.

In an embodiment of the invention some or all of the key ratio equations are default or system-generated key ratio equations. However, some or all of the key ratio equations may be user-defined key ratio equations. Here, a key ratio equation or all of the key ratio equations may have a numerator given by a single output flow from the corresponding subsystem. Preferably, a key ratio equation or all of the key ratio equations may have a denominator given by the total flow output from the corresponding subsystem plus the stock of the corresponding subsystem. Alternatively, some or all of key ratio equation may have a denominator given by the total flow input to the corresponding subsystem. It is preferred that the system-generated or user-defined key ratio equations are identified and displayed, and it is also preferred that the entered values of key ratios are displayed.

Also her it is preferred that a tag or a variable identifier is attached to each node and ach flow, said calculated and/or entered values of flows and/or stocks being displayed adjacent to th corresponding tag. Thus, for each subsystem the stock may be identified by a single-indexed tag. It is also within the first aspect of the invention that ach nod is linked to a dialog box allowing a user to assign th stock to b a dependent or an independent variable. Preferably, each flow is identified by a double-indexed tag referring to the system or subsystem of origin of the flow and of the receiving system or subsystem. Each flow may also linked to a dialog box allowing a user to assign the flow to be a dependent or an independent variable. When representing a key ratio equation, the flows in the key ratio equations may be represented by said double-indexed flow identifiers and the stocks may be represented by said single-indexed stock identifiers.

It is also within the method of the first aspect of the invention to have each flow graphically indicating the direction of the flow or resources. Thus, a flow may be represented by an arrow showing the direction of the flow of resources. Furthermore, a node may have the form of a rectangle. When displaying the variables, it is preferred that all entered values of independent variables and all calculated values of dependent variables are displayed. For variables having unknown values, the values of said variables may be displayed as unknown.

The subsystems may be divided in flow accounts and stock accounts, where for each subsystem being a flow account having the stock assigned as an independent variable, a key ratio equation is set up for each outgoing flow from the subsystem minus one, and where for each subsystem being a stock account having the stock assigned as a dependent variable, a key ratio equation is set up for each outgoing flow.

It should be understood that according to a method of the first aspect of the present invention, the values of the dependent variables in the form of output flows and/or stocks may be calculated as functions of the independent variables in the form of key ratios, input flow(s) from the giving system, and/or stock(s) of subsystems. In a preferred embodiment a method is provided in which the (n+m) linear equations are arranged in a form corresponding to a matrix equation with the values of the matrix elements being derived from the set of (n+m) linear equations and the entered values of independent variables. Here, the (n+m) linear equations may be arranged in a form of a matrix equation MA[i,j]*X=MB[i], where X is a solution vector comprising the dependent variables, MB[i] is a vector or matrix with a single column based on independent variables, and MA[i,j] is a quadratic coefficient matrix, wherein the values of the matrix elements of MA and MB are derived from the set of (n+m) linear equations and the entered values of independent variables. Preferably, each key ratio equation may be represented by a single row in the matrix equation, and each balance equation may be represented by a single row in the matrix equation. It is also within an embodiment of the method of the first aspect of the invention to calculate the values of the dependent variables by solving th matrix equation.

As already m ntion d, the present inv ntion also provides a computer processing system which may be characterised as operating in a so-called hindcast mode of operation.

Thus, according to a second aspect of the present invention there is provided a computer system for processing and display of variables representing stocks and flows of resources in a network diagram representing a balanced system, said system comprising:

a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,

a user interface for assigning for each subsystem one variable as a dependent variable, said dependent variable being either a flow of resources to or from said subsystem or the stock of resources contained in said subsystem,

means for assigning remaining flows and/or stocks of resources as independent variables,

a user interface for entering data representing values of some or all of the independent variables,

means for calculating values of some or all of the dependent variables based on the independent variables, and

means for displaying in the network diagram entered values of independent variables and calculated values of dependent variables.

The system of the second aspect of the invention may further comprise means for generating and/or defining, for each subsystem, a number of key ratio equations, each said key ratio equation being a dependent variable defined as a ratio, a fraction, with a linear combination of flows and/or stocks in the numerator and another linear combination of flows and stocks in the denominator, said generating means being adapted for generating, for each subsystem in which the stock is assigned as an independent variable, a default key ratio definition for each outgoing flow from the subsystem minus one, and said generating means being adapted for generating, for each subsystem in which the stock is assigned as a dependent variable, a default key ratio definition for each outgoing flow.

It is preferred that the means for calculating the values of the dep ndent variables is adapted for generating, for each subsystem, a balance equation, said balance equation stating the balance: flows of resources into the subsystem minus flows of resources out of the subsystem equals the stock of resources contained in the subsystem. Here, the means for calculating the values of the dependent variables may be adapted for calculating the values of the dependent variables based on a set of n simultaneous balance equations where n is the number of subsystems in the network.

Also in this aspect of the invention the system may be adapted for attaching a tag or a variable identifier to each node and each flow, said entered values of the independent flows and/or stocks variables and the calculated values of the dependent flows and/or stocks variables being displayed adjacent to the corresponding tag. Here, the system may be adapted for identifying the stock contained in each subsystem by a single-indexed tag, and the system may also be adapted to link each node to a dialog box allowing a user to assign the stock to be a dependent or an independent variable. For the flows it is preferred that the system is adapted for identifying each flow by a double-indexed tag holding information of the system or subsystem of origin of the flow and of the receiving system or subsystem, and the system may also be adapted to link each flow to a dialog box allowing a user to assign the flow to be a dependent or an independent variable.

When creating the network diagram the system may indicate for each flow the direction of the flow of resources. Thus, a flow may be represented by an arrow indicating the direction of the flow of resources. Furthermore, the system may be adapted to display each node in the form of a rectangle.

Several processes may be used for calculating the values of the dependent variables from the balance equations. According to an embodiment of the second aspect of the invention, the means for calculating the values of dependent variables may be adapted to perform a process comprising the steps of:

a) selecting a subsystem,

b) for said selected subsystem counting the number of variables having an unknown value, and if said number is greater than one selecting a new subsystem, or, if said number equals one,

c) calculate the value of the unknown dependent variable by means of the balance equation for the selected subsystem.

In order to run through all subsystems, the means for calculating the values of th depend nt variables should preferably be adapted to:

d) repeating steps a-c until all subsystems have been selected.

When the system has been through all the subsystems with corresponding balance equations, there may still be some values of dependent variables which have not been calculated. Thus, the means for calculating the values of dependent variables may further be adapted to:

e) when all subsystems have been selected according to steps a-d determining if one or more values of dependent variables have been calculated, if not, stop any further calculation of values of dependent variables, or if yes,

f) repeating steps a-d.

Here, the means for calculating the values of dependent variables may further be adapted to:

g) repeating steps a-f until no more values of dependent variables have been calculated.

Thus, the system may keep going through a calculation process until no further values of dependent variables are calculated.

It has already been mentioned that the system of the second aspect of the present invention may be adapted to include another type of dependent variables described as key ratios. Here, the system may comprise means for generating or, by means of a user interface, for user-defining a number of key ratios, each said key ratio being a dependent variable set equal to a fraction, or ratio, with a linear combination of flows and/or stocks in the numerator and another linear combination of flows and/or stocks in the denominator. The means for generating key ratio equations, which may be generated default key ratio equations, may be adapted to define the numerator by a single output flow from the corresponding subsystem. The means for generating key ratio equations may also adapted to define the denominator by the total flow output from the corresponding subsystem plus the stock of the corresponding subsystem. Alternatively, the means for generating key ratio equations may be adapted to define the denominator by the total flow input to the corresponding subsystem. When generating or defining the key ratio equations, the flows in the key ratio equations may be represented by said double-indexed flow identifiers, and the stocks may be represented by said single-indexed stock identifiers. The generated or defined key ratio equations are preferably displayed by the system.

When the system has calculated values of dependent variables being flows and/or stocks, then the system may use these values together with entered values of the independent values to determine values of key ratios as defined from the key ratio equations. Thus, the system may be adapted to calculate the numerical values of key ratios based on entered or calculated values of flows and/or stocks. The system may also be adapted to display the calculated values of th key ratios. The system may be adapted to display only part of the values of the independ nt and dependent variables, but it is preferred that the system is adapted to display all entered valu s of independent variables and all calculated values of dependent variables. If the value of a variable is not known or may not be determined, the system may display the value of such a variable as an unknown.

It is also within the second aspect of the present invention to have a system which is adapted to calculate several sets of values of dependent variables based on entered values of corresponding sets of independent variables. Here, the system may store each said set of calculated and entered values of variables, whereby each said set can be displayed one set at a time. Here, the sets of values of independent variables may be considered as inputs being changed in time, and for each point in time a change occurs on the input side, a new set of values of dependent variables may be determined.

The second aspect of the present invention also relates to a computer implemented method of operation. Thus, according to the second aspect of the invention there is provided a computer implemented method for processing and display of variables representing stocks and flows of resources in a network diagram representing a balanced system, said method comprising:

graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,

for each subsystem assigning one variable as a dependent variable, said dependent variable being either a flow of resources to or from said subsystem or the stock of resources contained in said subsystem, the remaining variables of stocks and flows being independent,

1entering and storing data representing values of some or all of the independent variables,

calculating values of some or all of the dependent variables based on the independent variables, and

displaying in the network diagram entered values of independent variables and calculated values of dependent variables.

According to a preferred embodiment of the method of the second aspect of the invention, ach subsystem has a corresponding balance equation, said balance equation giving a balance between flows of resources to and from the subsystem and the stock of resources of th subsystem. Thus, it is preferred that the calculation of the values of the dependent variables is based on a set of n simultaneous balance equations where n is th number of subsystems in the network.

Also here it is preferred that a tag or a variable identifier is attached to each node and each flow, and the calculated values of the dependent variables and the entered values of the independent variables may be displayed adjacent to the corresponding tag. It is also preferred that for each node or subsystem the stock contained in the subsystem is identified by a single-indexed tag, and that each node may be linked to a dialog box allowing a user to assign the stock to be a dependent or an independent variable. For a flow, it is preferred that the flow is identified by a double-indexed tag referring to the system or subsystem of origin of the flow and to the receiving system or subsystem. Here, the flow may be linked to a dialog box allowing a user to assign the flow to be a dependent or an independent variable.

Again, when creating a network diagram, it is preferred that each flow indicates the direction of the flow of resources. Here, the flow may be represented by an arrow indicating the direction of the flow of resources. Furthermore, a node may be displayed in the form of a rectangle.

In an embodiment of the second aspect of the invention, the method provides a process of calculating the values of the dependent variables, said process comprising:

a) selecting a subsystem,

b) for said selected subsystem counting the number of variables having an unknown value, and if said number is greater than one selecting a new subsystem, or, if said number equals one,

c) calculate the value of the unknown dependent variable by means of the balance equation for the selected subsystem.

In order to go through all subsystems, the process may further comprise:

d) repeating steps a-c until all subsystems have been selected.

When the process has been through all the subsystems with corresponding balance equations, there may still be some values of dependent variables which have not been calculated. Thus, the process of calculating the values of the dependent variables may further comprise:

e) when all subsystems have been selected according to steps a-d determining if one or more values of dependent variables have been calculated, if not, stop any further calculation of values of dependent variables, or if yes,

f) repeating steps a-d.

Also here, the process may further comprise:

g) repeating steps a-f until no more values of dependent variables have been calculated.

It has already been mentioned that the system of the second aspect of the present invention may be adapted to include another type of dependent variables described as key ratios. Thus, it is also within the method of the second aspect of the invention to generate and/or define for each sub-system a number of key ratio equations, each said key ratio equation having a dependent variable in the form of a key ratio set equal to a ratio or a fraction with a linear combination of flow and/or stocks in the numerator and another linear combination of flows and stocks in the denominator, where for each subsystem in which the stock is assigned as an independent variable a default key ratio equation is generated for each outgoing flow from the subsystem minus one, and for each subsystem in which the stock is assigned as a dependent variable a default key ratio equation is generated for each outgoing flow. The generated key ratio equations may be system generated default key ratios, while the defined key ratio equations may be defined by a user via a user interface.

In a preferred embodiment a subsystem has one or more corresponding key ratio equations, which may be default key ratio equations, and a key ratio may have a numerator defined by a single output flow from the corresponding subsystem. Here, a key ratio may have a denominator given by the total flow output from the corresponding subsystem plus the stock of the corresponding subsystem. Alternatively, a key ratio may have a denominator given by the total flow input to the corresponding subsystem plus. The flows in the key ratio equations may be represented by said double-indexed flow identifiers, while the stocks may be represented by said single-indexed stock identifiers.

It is preferred that the values of some or all of the key ratios are calculated when the values of flows and/or stocks corresponding to the definition given by the key ratio equations have been entered or calculated. Preferably, the calculated values of the key ratios are displayed, and it is also preferred that all entered values of independent variables and all calculated values of dependent variables are displayed. Here the values of the flows and stocks may be displayed in the network diagram. When the value of a variable is unknown, the value of said variable may be displayed as unknown, for example by a question mark.

The stock of a subsystem may be assigned as an independent or a dependent variable. If the stock is an independent variable, the subsystem may be named a flow account having one flow assigned as a depend nt variable, the remaining flows and the stock of said subsystem being independent variabl s. If the stock is a dependent variable, the subsystem may b named a stock account having the stock assigned as a dependent variable and all flows of said subsystem being independent variables.

It should be understood that according to the different aspects of the present invention, the resource flowing in the balanced system may be selected from a group of resources comprising: money, energy, and materials.

The present invention also provides a processing system which may be used both in the hindcast and the forecast mode of operations. Thus, according to a third aspect of the present invention, there is provided a computer system for processing and display of variables in a user generated network diagram representing a balanced system, said variables representing stocks and flows of resources and key ratios being ratios of linear combinations of flows and/or stocks of resources, said system comprising:

a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources to or from a subsystem,

means for assigning, for each subsystem, the variables in the form of flows of resources and stocks of resources as dependent or independent variables, means for generating and/or user-defining, for each subsystem, a number of key ratio equations, each said key ratio equation consisting of a key ratio being a variable set equal to a fraction or a ratio with a linear combination of flows and/or stocks in the numerator and another linear combination of flows and/or stocks in the denominator, said number of key ratio equations being equal to the number of dependent variables assigned to said subsystem minus one,

a user interface for entering data representing values of some or all of the independent variables,

means for calculating values of some or all of the dependent variables based on values of independent variables, and

means for displaying entered values of independent variables and calculated values of dependent variables.

Here, the means for calculating the values of the dependent variables is preferably adapted for generating or user-defining, for each subsystem, a balance equation, said balance quation stating the balance: flows of resources into the subsystem minus flows of resources out of the system equals the stock of resources contained in the subsystem.

The system may further comprise a user interface for selecting either a hindcast or a forecast mode of operation. When the system is selected to be in the forecast mode of operation, the system may comprise:

means for assigning, for each subsystem, all output flows of resources from said subsystem as dependent variables,

a user interface for assigning, for each subsystem, the stock of resources as either a dependent or an independent variable,

means for assigning all flow of resources from the giving system into a node as an independent variable, and

means for assigning all key ratios as independent variables.

When the system is set to the forecast mode of operation, the system may by default assign all stocks as independent variables.

It should be understood that when set to the forecast mode op operation, the system may further comprise any of the embodiments of systems according to the first aspect of the invention.

When the system of the third aspect of the invention is selected to be in the hindcast mode of operation, the system may comprise:

means for assigning all key ratios as dependent variables, and

a user interface for assigning, for each subsystem, one variable as a dependent variable, said variable being either a flow of resources or the stock of resources of said subsystem, and

means for assigning flows and/or stocks of resources as independent variabl s.

It should be understood that when set in the hindcast mode of operation, the system may further comprise any of the embodiments of systems according to th second aspect of the invention.

In order to obtain a computer processing system of the pres nt invention, a computer program may be provided for programming or adapting a computer accordingly.

Thus, it is within the present invention to provide a first computer program comprising computer program code means for adapting a computer to a system selected from the embodiments of systems according to the first aspect of the invention when said program is installed on the computer. The first computer program may preferably be embodied on a computer-readable medium.

It is also within the present invention to provide a second computer program comprising computer program code means for adapting a computer to a system selected from the embodiments of systems according to the second aspect of the invention when said program is installed on the computer. The second computer program may preferably be embodied on a computer-readable medium.

It is also within the present invention to provide a third computer program comprising computer program code means for adapting a computer to a system selected from the embodiments of systems according to the third aspect of the invention when said program is installed on the computer. The third computer program may preferably be embodied on a computer-readable medium.

The present invention may include the energy/materials dimension (the environmental dimension), and applies to any conserved quantity. The invention is a simple solution to an apparently insoluble problem: the provision of a simple, and yet universal, method and software system for financial accounting, budgeting and management as well as environmental accounting and management.

In terms of effect and functioning it seems appropriate to compare the present invention to the invention of VisiCalc in 1979. Both are characterised by combining knowledge from diverse fields into a not previously seen whole. In the case of VisiCalc its effect was that one did not have to be a programmer in order to use the computer. In the case of the present invention the effect is that one does not have to be an auditor or an accountant to set up, predict, and manage accounts in monetary as well as physical units.

### BRIEF DESCRIPTION OF THE DRAWINGS

Th invention may best be understood by reference to the accompanying drawings in which:

FIG. 1 shows a screen view of a network diagram of a balanced system comprising a singl subsystem visualised by a processing system according to an embodiment of the present invention,

FIG. 2 shows that the subsystem in FIG. 1 is located between a giving and a receiving reservoir or system,

FIG. 3 shows a print-out of a balanced system comprising two interacting subsystems,

FIG. 4 shows the input-output and the key ratio matrices of the network diagram (graph) in FIG. 3,

FIG. 5 shows a network diagram of a balanced financial system comprising eight subsystems (accounts),

FIG. 6 shows a screen view of the network diagram in FIG. 5 visualised by a processing system according to an embodiment of the present invention,

FIG. 7 illustrates flows in network diagram representing the nitrogen cycle of agriculture,

FIG. 8 shows a balanced system representing the nitrogen account of Danish agriculture in million kg N in the middle of the 1980ies,

FIG. 9 shows a balanced system representing an account plan for a company selling counselling and software;

FIG. 10 shows a balanced system representing an energy account in 1000 kWh per annum for a company producing plastic devices,

FIGS. 11a-11c are flow chart showing an algorithm for calculating dependent variables in the hindcast mode of operation according to an embodiment of the present invention,

FIG. 12 is a flow chart showing an algorithm for calculating dependent variables in the forecast mode of operation according to an embodiment of the present invention,

FIGS. 13a, 13b are flow chart showing an algorithm for processing key ratio equations according to an embodiment of the present invention, said algorithm being part of the algorithm of FIG. 12,

FIGS. 14a-14d are flow chart showing an algorithm for processing an Operational String according to an embodiment of the present invention, said algorithm being part of the algorithm of FIG. 13,

FIG. 15 is a flow chart showing an algorithm for deriving Column Number and Operational Term according to an embodiment of the present invention, said algorithm being part of the algorithm of FIG. 14,

FIGS. 16a-16g are flow chart showing an algorithm for processing balance equations according to an embodiment of the present invention, said algorithm being part of the algorithm of FIG. 12,

FIG. 17 shows an example of a balanced system in hindcast mode according to an embodiment of the present invention, and

FIG. 18 shows an example of a balanced system in a forecast mode according to an embodiment of the present invention.

### DESCRIPTION OF PREFERRED EMBODIMENTS OF THE INVENTION

The method and system of the present invention may be based on three axioms:

1. Double entry bookkeeping concerns accounting for conserved quantities. The same amount is entered in two places. Nothing disappears and nothing is created in the transfer of money from one account to another. In other words: in double entry bookkeeping, flows and stocks of money behave exactly as flows and stocks of energy and materials. Mathematically it makes no difference whether the currency is $ or kg nitrogen for example. Double entry bookkeeping is “made” to account for all conceivable conserved quantities in natural and man-made systems.

2. A mathematical model is formed in three steps: 1) counting the unknowns, the dependent variables, 2) setting up simultaneous equations in the same number, and 3) solving them.

3. if one adds the balance equation for a group of subsystems, one obtains the balance equation for a control volume containing the group. One can thus perceive a single system as the result of a group of interacting subsystems or, conversely, a group or a network of subsystems, as a single system. The method begins by considering the entire system under study placed in a single control volume, hereafter as a group of interacting subsystems, each of which in turn can be perceived as yet another group of interaction subsystems, and so on. The structure is hierarchical

The generalised model of double entry bookkeeping consists of two combinations of linear equations called mod s of operation. One mode (‘hindcast’) is applied when setting up and predicting financial or energy/materials accounts. The equations are the balance equations, one for each subsystem in the network. The other (forecast’) is applied for financial and environmental management by means of key ratios and inputs from the giving system. Here the equations are the aforementioned balance equations in addition to equations defining key ratios in a number necessary and sufficient to close the system of equations governing each subsystem.

The special thing about the processing system of the present invention is that it may set up the equations in addition to solving them. Hence, in order to create an input-output model, the user practically needs only to draw his system as a network diagram and “count” the unknowns.

The input-output matrix is visualised as a graph or network diagram with flows of resources between the network's nodes and stocks contained in these nodes. Two modes of presentation may be obtained: the accounting matrix and the network visualisation, which are equivalent in terms of information, the difference being that the network is much easier to grasp.

A Single Subsystem in Hindcast

In making a model it is wise to start simple and keep it simple. In that spirit, let us assume that the system under study is a bathtub with an input, an output, and a stock of water. We can also say that is a bank account with an input, an output, and a stock, a pile of money, the balance, but let's stick to the hydraulic metaphor, because it is easier to picture water in a tub than money in a bank account.

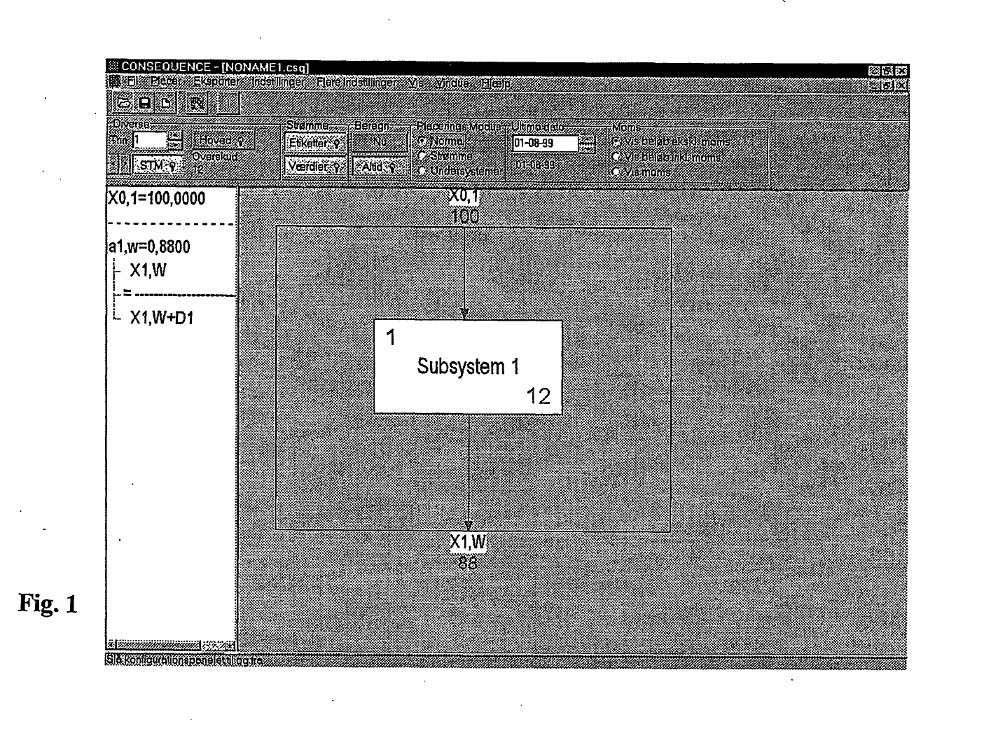

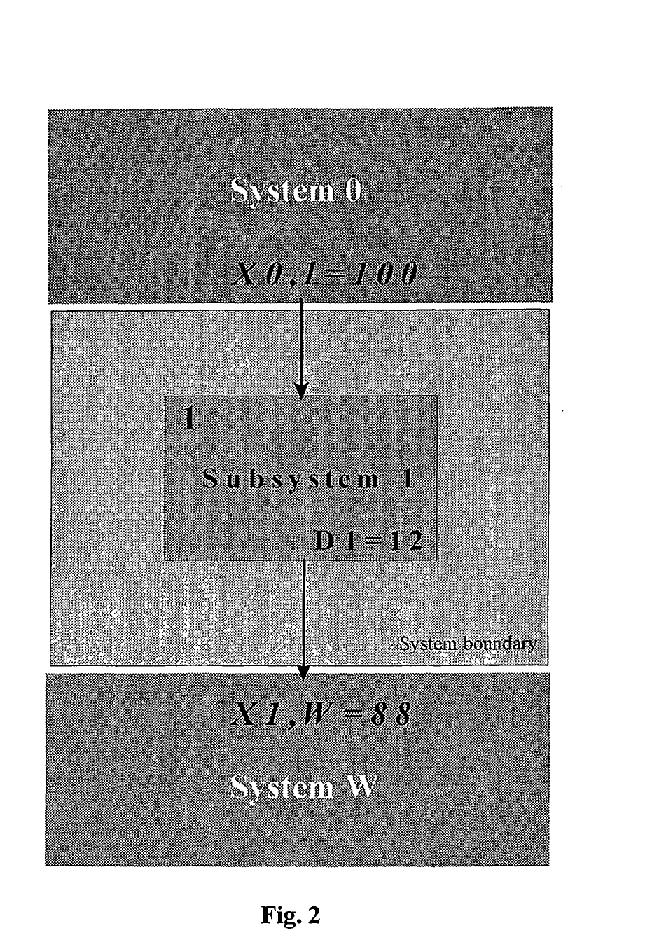

Imagine a rectangle on the screen see FIG. 1. The borderline is the boundary of a system under study. In the beginning, it is empty. Somewhere in the middle we ‘drop’ a smaller rectangle. This is subsystem 1, the bathtub. We then draw an arrow pointing from an unbalanced reservoir or system above the system boundary called System 0 (see FIG. 2) into subsystem 1. This arrow represents the input of water, the flow accumulated up to a certain, point in time (t), say t=t₁. It is tagged X0,1, meaning the accumulated flow from System 0 into subsystem 1. Similarly, we draw an arrow from the bottom of the tub to an unbalanced reservoir below the system boundary called System W, see FIG. 2. This arrow is tagged X1,W. It represents the output of water, the accumulated flow from subsystem 1 into System W.

In the lower right hand corner we have a variable D1, the stock, representing the amount of water that the tub contains at t=t₁. Taking this amount to be zero at t=0 we have

D1=X0,1 −X1,W

Stock=input−output

The processing system of the present invention may automatically generate this simpl model from the information contained in the user's drawing of the network, saying that the stock at any time (t=t₁) is qual to the input minus the output both accumulated from t=0 to t=t₁.

The model consists of three variables. We can measure any two of them and calculate the third from the balance. For the sake of argument, let us initially suppose that we record the flows X0,1 and X1,W and calculate the stock D1. Suppose also that the water does not flow continuously, but comes in instantaneous ‘packages’. These packages can then be pictured as a time series of ‘pulses’ situated along the time axis. The model adds up all X0,1 pulses and subtracts all X1,W pulses up to and including the time t=t₁ to calculate the stock, the amount of water in the tub, at t=t₁.

This brings us back to the bank account, because that is essentially how it works. We don't actually put in or take out money; we just apply this simple model and calculate a new balance each time a pulse “passes”.

The processing system according to the present invention may generate the balance equation from the user's drawing of a network diagram and make sure that the correct balance, the actual stock, is calculated after each and every pulse of water entering or leaving the tub, or pulse of money entering or leaving the bank account.

In the financial metaphor we can then create a list of transactions, recording the time of occurrence and the amount of water or money moved in each pulse. We can picture a cursor positioned on the time axis at t=t₁ or in fact at any time in the list. The balance can then be depicted by a step curve with a new step every time the cursor passes a pulse, an input or an output. The curve begins at t=0 and ends at the last transaction in the list.

In financial analysis we apply so called key ratios as a means of characterising the performance or structure of an economic system. The same can be done in energy and materials accounting (green accounting). For instance, we can define a dependent variable, a key ratio, which we may call the expense ratio:

$$a 1 , w = \frac{X 1 , W}{X 1 , W + D 1}$$

as a fourth variable shown in the list to the left of the graph in FIG. 1 calculated at 0,88. in hindcast mode key ratios are per definition dependent variables.

One can speak of input and output in two different m anings: 1) in terms of input of a physical quantity to a system and output of a physical quantity from that system 2) in terms of input of data to a model and output of data from that model. The data we put into the model are independent variables, the data output from the model are dependent variables since they depend on the independent. So, dependent, or calculated variables, also called ‘unknowns’, are functions of independent or recorded variables, also called ‘knowns’.

In the example above we assigned the stock D1 to be the dependent variable and the two remaining variables to be independent. However, we can assign any of the three variables to be dependent, noting that we can have only one such variable since we (in hindcast mode) have only one equation, namely the balance equation.

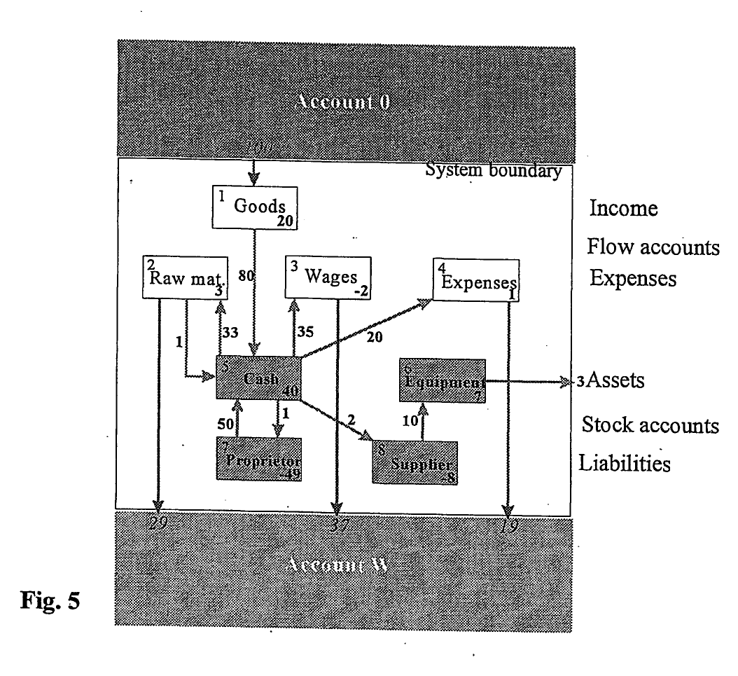

A distinction is made between two types of accounts: flow accounts and stock accounts. Flow accounts (in which stocks per definition are independent variables) belong to the group income and expenses, while stock accounts (in which stocks per definition are dependent variables) belong to the group assets and liabilities, see FIG. 5. If a stock is assigned to be a dependent variable, then the account in which the stock is found is a stock account. If a stock is assigned to be an independent variable, then the account in which the stock is found is a flow account.

Networks of Subsystems in Hindcast

On this simple basis we can extend the analysis from one subsystem to a network of subsystems. This enables us to calculate the balance sheet of a business like we calculate the balance of a bathtub or a bank account. The processing system may work with n balance equations, where n is the number of subsystems in the system. So, instead of generating and solving only one equation with one unknown, the processing system of the present invention may generate and solve n equations with n unknowns. We can think of the system as a network of bathtubs exchanging water with other tubs inside and outside the system boundary, or we can think of it as a network of accounts exchanging money with accounts inside and outside the system boundary. The mathematics is the same. We can also think of the network as a hydrological or an ecological model, or a model of the economy of a business.

If we think of it as an economic model, the network is an account plan. We can then record the independent variables, enter them into a long list of transactions and calculate a new value, a new step on a curve, after each transaction for all elements of the account, including the elements of the income statement and the balance sheet. This makes it a powerful early warning and management tool since one can predict transactions fairly accurately and hence predict the financial balance with th same accuracy, see also ° Further examples of networks' below.

A Single Subsystem in Forecast

Embodiments of a processing system of the present invention may run ‘forwards’ and ‘backwards’, in forecast and in hindcast mode. Remembering that the processing system may be an input-output model-maker, we may say that when we run the model backwards, i.e. when we are in hindcast mode, we calibrate it, while when we run it forwards, i.e. when we are in forecast mode, we apply it.

Up to this point, the model has been in hindcast mode. A user can now switch to forecast mode in which key ratios per definition are independent variables. The processing system may then automatically assign all outputs from subsystems to be dependent variables (in addition to stocks in stock accounts). The processing system may convert the key ratio from a model output to a model input, i.e. from a variable that merely reflects the performance of the system to a variable that governs it. In the example in FIG. 1 we now have two dependent variables (D1 and X1,W) requiring two equations. The first equation is the balance equation. The second is the above stated equation defining the key ratio a1,W. Hence, we now calculate D1 and X1,W as a function of X0,1, and a1,W.

In the example above the possible arrangements of variables in hindcast and forecast are:

| | Dependent | Independent |
|---|---|---|
| | (Data out) | (Data In) |
| Hindcast | D1;a1,W | X0,1;X1,W |
| | X0,1;a1,W | D1;X1,W |
| | X1,W;a1,W | D1;X0,1 |
| Forecast | D1;X1,W | X0,1;a1,W |

In forecast, a user can then by a click change the entered value of the (material) input X0,1 and/or the key ratio a1,W and calculate D1 and X1,W at each click.

In forecast, the list of transactions is no longer of interest. Now we speak, not of short term management of the system by controlling transactions, we speak of long term management by controlling inputs from the exterior, and key ratios (notably efficiencies) in the interior of the system.

Returning to the hydraulic metaphor we can let the subsystem be a reservoir and let X₁,W be a leak, a waste of water. The key ratio then states how much of the input to the reservoir is being wasted. According to FIG. 1 the waste ratio is 0,88 or 88 per cent. Suppose that good water management were to store as much water as possible. In that case we have three options: We can 1) increase the resource input, 2) decrease the waste ratio, or 3) combine these two options.

The same applies to the bank account. If good economic management were to “pile up” as much money as possible, this can be achieved in three ways: We can 1) increase the input, 2) decrease the expense ratio, or 3) combine the two.

Networks of Subsystems in Forecast

Mathematically it is a small step to generalise what is stated above for a single subsystem to a network of subsystems. In terms of management of both physical and economic systems it is, however, a considerable step. A processing system according to an embodiment of the present invention may take that step and establish an input-output model of a complex network of subsystems without the user knowing it, based on the information that the user transfers to the software system, merely by drawing the network diagram.

A processing system of the present invention may generate the list of key ratios so that the number of ratios is necessary and sufficient to close the system of equations, i.e. to make the model work. The number of key ratios is determined in forecast mode based on axiom No. 2. Consider first a system consisting of a network of n subsystems, all of which are flow accounts. Stocks in flow accounts and inputs from the exterior are by definition independent variables, and all outputs from subsystems are by definition dependent variables in forecast. The number of necessary and sufficient key ratio equations is therefore equal to the total number of outputs from subsystems in the system or network (nₒ).

The equations are of two kinds: Balance and key ratio equations. Since the number of balance equations is equal to the number of subsystems, the number of key ratio equations (and key ratios) is equal to the number of outputs from subsystems (n₀) minus the number of subsystems. This applies if all accounts are flow accounts, i.e. when the number of stock accounts is zero.

If the number of stock accounts is nₛ, we have nₛ extra dependent variables. In order to close the system of equations we therefore have to add nₛ key ratio equations. Hence, in general the number of key ratios definitions or equations (nₖ) in a system or network is:

nₖ=nₒ−n+nₛ

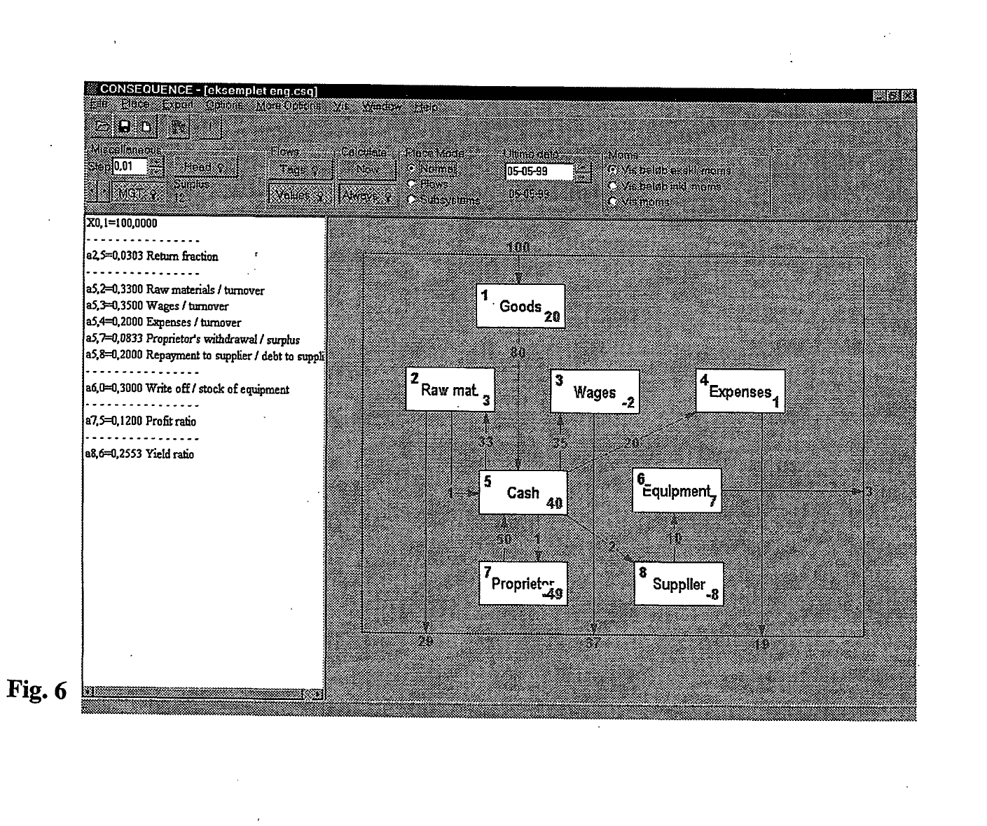

For example in FIG. 6 we hav nₒ=13; n=8 and nₛ=4 and therefore 13−8+4=9 key ratios listed to the left of the graph.

Initially (as default) an embodiment of a processing system of the present invention may apply a certain class of key ratios called output coefficients, see below. A user can overwrite the numerator and the denominator to obtain physically or financially meaningful key ratios. For instance, if we are dealing with a physical system, the user can define the efficiency of a subsystem and enter this definition. The processing system may then accept the definition as a governing equation and include it in the set of equations on which it operates. From now on the manager may be in control of flows and stocks in the entire network by controlling inputs and key ratios.

Four Combinations

At this point it is appropriate to consider the structure of a preferred embodiment of a processing system of the present invention. We may have two modes of modelling: hindcast and forecast and we may have two ‘currencies’: energy and materials (called ‘green’) and money (called ‘financial’). This gives four combinations:

| | Green | Financial |
|---|---|---|
| Hindcast | A | B |
| Forecast | C | D |

Common for all four combinations we have the following steps:

a. a user creates a network diagram in which a subsystem embedded in a larger system is a node (containing a stock) and a connection between subsystems (and between subsystems and unbalanced systems outside the system) is represented by an arrow representing a flow,

b. a user assigns variables to be either dependent (data out) or independent (data in),

c. the processing system may generate and display a list of key ratios and their definition in the necessary and sufficient number,

d. a user is invited to define non-default (custom) key ratios,

e. a user enters independent variables,

f. the processing system may generate and solve a set of simultaneous linear equations ensuring that the number of equations is equal to the number of dependent variables,

g. the processing system may display the values of th variables in the network diagram and in th list generated in step c whenev r a new value of any of the independent variables is entered.

The steps in each of the four combinations are:

A. Green, Hindcast

a. a user creates a network diagram in which a subsystem embedded in a system is a node (containing a stock) and a connection between subsystems (and between subsystems and unbalanced systems outside the system) is represented by an arrow carrying a flow,

b. assigning one flow among the flows connected to each subsystem to be a dependent variable, and stocks to be independent variables,

c. the processing system may generate and display a list of key ratios in the necessary and sufficient number,

d. a user may define non-default key ratios,

e. a user enters independent variables,

f. generating a set of simultaneous linear equations consisting of the subsystems' balance equations only,

g. the processing system may display the values of the variables in the network diagram and in the list generated in step c whenever a new value of one of the independent variables is entered.

B. Financial, Hindcast

a. a user creates a network diagram in which a subsystem embedded in a system is a node (containing a stock) and a connection between subsystems (and between subsystems and unbalanced systems outside the system) is represented by an arrow carrying, a flow,

b. assigning one flow among the flows connected to each subsystem to be a dependent variable, and stocks to be independent variables,

c. the processing system may generate and display a list of key ratios in the necessary and sufficient number,

d. a user may define non-default key ratios,

e. a user enters independent variables,

f. generating a set of simultaneous linear equations consisting of the subsystems' balance equations only,

g. the processing system may display the values of the variables in the network diagram and in the list generated in step c whenever a new value of any of the independent variables is ntered,

h. assigning stocks in stock accounts to be dependent variables, leaving flows connected to stock accounts to be independent variables,

i. creating and storing a list of business transactions, i.e. a database of time series of increments of independent variables,

j. displaying and storing income statement and balance sheet at any time selected between the beginning and the end of the list of business transactions,

k. storing graphical images of the variables from the beginning to the end of the list of business transactions.

C. Green, Forecast

a. a user creates a network diagram in which a subsystem embedded in a system is a node (containing a stock) and a connection between subsystems (and between subsystems and unbalanced systems outside the system) is represented by an arrow carrying a flow,

b. assigning outputs from each subsystem to be dependent variables,

c. The processing system may generate and display a list of key ratios in the necessary and sufficient number,

d. a user may define non-default key ratios,

e. a user enters independent variables,

f. generating a set of simultaneous equations consisting of the subsystems' balance equations in addition to key ratio equations,

g. the processing system may display the values of the variables in the network diagram and in the list generated in step c whenever a new value of any of the independent variables is entered.

D. Financial, Forecast

a. a user creates a network diagram in which a subsystem embedded in a system is a node (containing a stock) and a connection between subsystems (and between subsystems and unbalanced systems outside the system) is represented by an arrow carrying a flow,

b. assigning outputs from each subsystem to be dependent variables,

c. The processing system may generate and display a list of key ratios in the necessary and sufficient number,

d. a user may define non-default key ratios,

e. a user enters independent variables,

f. generating a set of simultaneous equations consisting of the subsystems' balance equations in addition to equations defining key ratios,

g. The processing system may display the values of the variables in the network diagram and in the list generated in step c whenever a new value of any of the independent variables is entered,

h. assigning stocks in stock accounts to be dependent variables, leaving flows connected to stock accounts to be independent variables,

i. displaying income statement and balance sheet whenever a new value of one of the independent variables is entered.

Combination A+C covers green accounting. To include financial accounting dimension (combinations B+D) is merely a matter of distinguishing between flow and stock accounts and add a few further steps. Financial and green accounting are not only analogous, they are mathematically identical. The financial dimension thus emerges by adding steps specific to financial accounting and management, for instance the list of business transactions, the set up of the income statement, the balance sheet, and graphical features relevant to financial management.

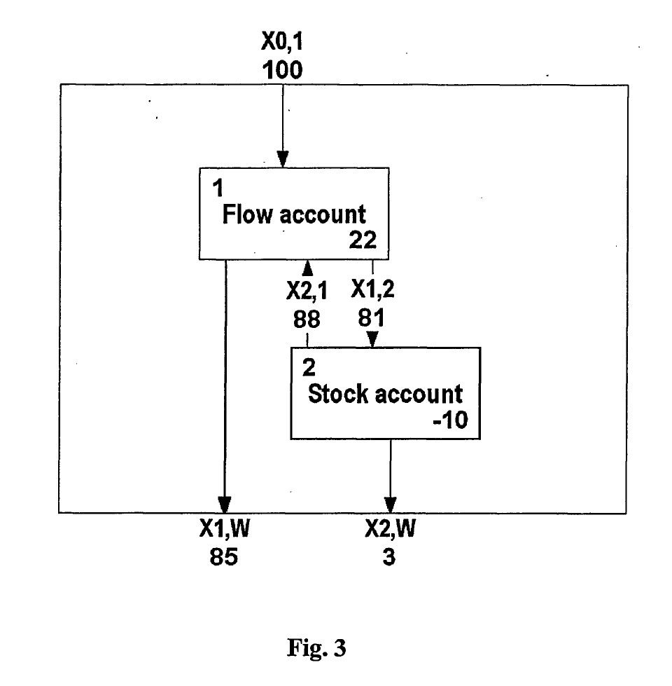

Further Examples of Networks (FIGS. 3-10)

Up to this point the description has concentrated on a single subsystem, a bathtub or a bank account, while only hinting how a processing system according to the present invention may work on networks of subsystems. In the following we will consider the equations actually applied to networks of subsystems.

According to axiom No. 3, the system in FIGS. 1 and 2 can be perceived as the result of a number of interacting subsystems within the system. For instance, it could be two subsystems in interaction as shown in FIG. 3. Noting that X1,W+X2,W=88 and D1+D2=22−10=12 we see that this is actually so.

Account No. 1 in FIG. 3 is a flow account in which the stock per definition is an independent variable. Account No. 2 is a stock account in which the stock per definition is a dependent variable. Hence, D1=22 is a known, part of the model input. In FIG. 3, a processing system according to the present invention calculates D2=−10 as part of the model's output.

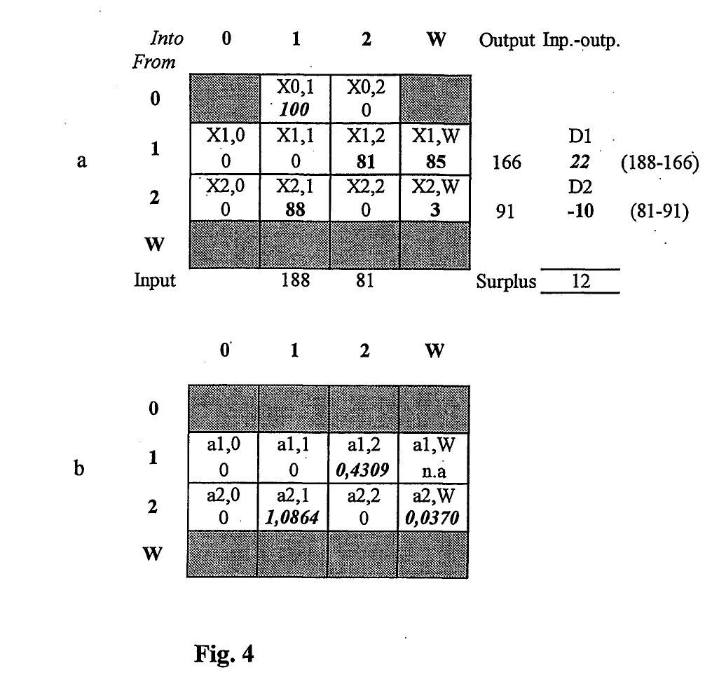

FIG. 4a shows the input-output matrix behind the graph in FIG. 3. It is Leontief input-output table supplem nted with the two previously mentioned reservoirs System 0 and System W.

The flow from account i into account j is designated Xi,j which is th matrix element in row i and column j. If we add the figures in row i, we get the total output from system i. From FIG. 3 we see that the total output from subsystem 1 is 85+81=166 which is the sum of the figures in row 1. If we add the numbers in column i we get the total output from subsystem i. From FIG. 3 we see that the total input into system 1 is 100+88=188 which is the sum of column 1.

FIG. 4b is the key ratio matrix derived from the input-output matrix. We read both tables by rows. In row No. 1 (FIG. 4a) we have three variables in forecast mode: X1,2, X1,W and D1 of which D1 is known. The two unknowns (X1,2 and X1,W) require two equations. One is the balance equation:

D1=X0,1+X2,1−X1,2−X1, W

The other is a key ratio definition or equation. In default it is an output coefficient:

$$Default ai , j = - \frac{Xi , j}{{\sum }_{k = 1 , 2 … W} Xi , k + Di}$$

where i is the number of the current subsystem, j is the number (plus the letter W for the receiving system) of the subsystem or system to which the output goes. Xi,j is a flow from subsystem i into subsystem j, and Di is the stock in subsystem i. The denominator is the sum of all outputs from the subsystem plus the stock contained in the subsystem.

A user can choose default key ratios or form his own custom key ratio definitions or equations. He can delete the numerator and/or the denominator and instead enter linear combinations of a mixture of dependent and independent variables.

In the present example (the graph in FIG. 3) we need only one key ratio equation, which in default is:

$$Default a 1 , 2 = \frac{X 1 , 2}{ X 1 , 2 + X 1 , W + D 1}$$

The processing system may use ai,j=0.1000 as the default value of the ratios in order to solve the equations and produce a working input-output model. In forecast, a user can later change this value as he wishes since it is an independent variable in that mode of operation.

We can eras the denominator and for example enter for xample X0,1+X2,1 to produce a custom key ratio d finition or equation. In this case, the default and the custom key ratio quations happens to be identical by virtue of the balance equation.

$$Custom a 1 , 2 = \frac{X 1 , 2}{ X 0 , 1 + X 2 , 1} = \frac{81}{100 + 88} = 0 \text{,} 4309$$

Theoretically, we can form an additional key ratio, namely a1,W, but there is no need for it since we already have the two required equations.

In forecast mode, a processing system according to the present invention may include the key ratio equation along with the balance equation to complete the set of equations governing subsystem 1.

Similarly for subsystem 2: Three variables (X1,2; X1,W and D2), three unknowns, and three equations. One is the balance equation:

D2=X1,2−X2,1−X2, W

The two remaining equations are

$$Default a 2 , 1 = \frac{X 2 , 1}{ X 2 , 1 + X 2 , W + D 2}$$

or for example

$$Custom a 2 , 1 = \frac{X 2 , 1}{ X 1 , 2} = \frac{88}{81} = 1.0864$$

$$and$$

$$Default a 2 , W = \frac{X 2 , W}{ X 2 , 1 + X 2 , W + D 2}$$

or for example

$$Custom a 2 , W = \frac{X 2 , W}{ X 1 , 2} = \frac{3}{81} = 0.0370$$

In forecast mode, the processing system may include the two key ratio equations along with the balance equation to complete the set of equations governing subsystem 2.

The unknowns are arranged in the following order:

X1,2; X1,W; X2,1; X2,W; D2

In this example we choose the custom key ratio equations, place terms containing the unknowns on the lefthand side and terms containing the knowns on the right:

$$\begin{matrix}- X1 , 2 & - X 1 , W & + X 2 , 1 & & = D 1 - X 0 , 1 \\ X1 , 2 & & - X 2 , 1 & - X 2 , W - D2 & = 0 \\ X1 , 2 & & - a 1 , 2 * X 2 , 1 & & = a 1 , 2 * X 0 , 1 \\ - a 2 , 1 * X 1 , 2 & & + X 2 , 1 & & = 0 \\ - a 2 , W * X 1 , 2 & & & + X 2 , W & = 0\end{matrix}$$

The two first equations are the balance equations, the remaining three are the custom key ratio equations in rearranged form.

The equations in matrix-form:

$$\vert \begin{matrix}- 1 & - 1 & 1 & 0 & 0 \\ 1 & 0 & - 1 & - 1 & - 1 \\ 1 & 0 & - a 1 , 2 & 0 & 0 \\ - a 2 , 1 & 0 & 1 & 0 & 0 \\ - a 2 , W & 0 & 0 & 1 & 0\end{matrix} \vert * \vert \begin{matrix}X 1 , 2 \\ X 1 , W \\ X 2 , 1 \\ X 2 , W \\ D2\end{matrix} \vert = \vert \begin{matrix}D 1 - X 0 , 1 \\ 0 \\ a 1 , 2 * X 0 , 1 \\ 0 \\ 0\end{matrix} \vert$$

Inserting the independent variables (a1,2=0.4309; a2,1=1.0864; a2,W=0.0370; D1=22 and X0,1=100) yields:

$$\vert \begin{matrix}- 1 & - 1 & 1 & 0 & 0 \\ 1 & 0 & - 1 & - 1 & - 1 \\ 1 & 0 & - 0 \text{,} 4309 & 0 & 0 \\ - 1 \text{,} 0864 & 0 & 1 & 0 & 0 \\ - 0 \text{,} 0370 & 0 & 0 & 1 & 0\end{matrix} \vert * \vert \begin{matrix}X 1 , 2 \\ X 1 , W \\ X 2 , 1 \\ X 2 , W \\ D2\end{matrix} \vert = \vert \begin{matrix}- 78 \text{,} 000 \\ 0 \text{,} 000 \\ 43 \text{,} 090 \\ 0 \text{,} 000 \\ 0 \text{,} 000\end{matrix} \vert$$

The solution is

$$\vert \begin{matrix}X1 , 2 \\ X1 , W \\ X2 , 1 \\ X2 , W \\ D2\end{matrix} \vert = \vert \begin{matrix}81 \\ 85 \\ 88 \\ 3 \\ - 10\end{matrix} \vert$$

as shown in the graph in FIG. 3.

The linear equations may be solved in several ways, an example of which will be described below. According to the present invention a processing system may be provided which sets up a valid set of equations (i.e. ‘makes’ an input-output model) leaving it to the user only to make up his mind what he wishes to measure (assign variables to be independent), and what to calculate (assign variables to be dependent).

The equations above refer to forecast mode. If we switch to hindcast mode, the processing system “knows” that only the first two equations, the two balance equations, apply. The processing system now demands that only two variables be dependent.

Part of the philosophy of the approach is to keep it simple and thoroughly understand simple numerical examples. The reward of an in-depth understanding of simple numerical examples is that it becomes easy to generalise to networks with any number of subsystems.

FIG. 5 is a further detailing of FIG. 3 like FIG. 3 was a detailing of FIG. 1. Subsystem 1 in FIG. 3 is perceived as four interacting subsystems in FIG. 5 in the income and expenses group of accounts called flow accounts. Likewise, subsystem No. 2 in FIG. 3 is in FIG. 5 perceived as another four interacting subsystems in the asset and liabilities group of accounts called stock accounts.

Suppose that the system in FIG. 5 is in financial-hindcast (combination B). Then there are 22 variables, 14 flows and eight stocks. Since we have eight balance equations, we need only record 22-8=14 of the variables. These 14 independent variables are 10 transactions taking place in a given period of time in addition to four stocks at the end of that period.

The 10 transactions are:

| | | | |
|---|---|---|---|
| 1 | The proprietor contributes | 50 | X7,5 |
| 2 | Equipment is purchased from a supplier at | 10 | X8,6 |
| 3 | Raw materials is purchased at | 33 | X5,2 |
| 4 | Expenses (rent, power, etc) is paid by | 20 | X5,4 |
| 5 | Wages are paid by | 35 | X5,3 |
| 6 | Damaged raw materials are returned and compensated by | 1 | X2,5 |
| 7 | Goods are sold for | 80 | X1,5 |
| 8 | Debt to supplier paid off by | 2 | X5,8 |
| 9 | Depreciation | 3 | X6,0 |
| 10 | The proprietor withdraws | 1 | X5,7 |

The stocks in the four flow accounts are:

| | | |
|---|---|---|
| 11 A stock of goods worth | 20 | D1 |
| 12 A stock of raw materials worth | 3 | D2 |
| 13 Wages owed | −2 | D3 |
| 14 Rent paid in advance | 1 | D4 |

These 14 independent variables are shown in bold type in FIG. 5. The eight calculated values are shown in italics. The 22 variables constitute together the data, which are necessary and sufficient income statement and the balance sheet.

Since we have established the relationship between the balance sheet on the one hand and the business transactions on the other, we now have the balance sheet as a function of time. The balance sheet is updated immediately after the last business transaction is entered. The balance sheet is a function of the transactions, which in turn is a function of time. Not only can we produce contiuously updated balance sheets, we can also predict all their components, for instance the liquidity.

The income statement and the balance sheet in a traditional format printed from a processing system according to the present invention after entering the 14 independent variables mentioned above as follows:

INCOME STATEMENT

| | | |
|---|---|---|
| Produced goods | X0,1 | 100 |
| Total | | 100 |
| Raw materials | X2,W | 29 |
| Wages | X3,W | 37 |
| Expenses | X4,W | 19 |
| Depreciation | X6,0 | 3 |
| Surplus | D | 12 |
| Total | | 100 |

BALANCE

| | | |
|---|---|---|
| Assets | | |
| Stock of goods | D1 | 20 |
| Stock of raw materials | D2 | 3 |
| Rent paid in advance | D4 | 1 |
| Cash in hand | D5 | 40 |
| Stock of equipment | D6 | 7 |
| Balance | | 71 |
| Liabilities | | |
| Wages owed | D3 | 2 |
| Proprietor's Investment | D7 | 49 |
| Debt to supplier | D8 | 8 |
| Surplus | D | 12 |
| Balance | | 71 |

From FIG. 5 this can be read directly, noting that the surplus can be calculated in two different ways, either from flows crossing the system boundary:

Surplus=100−(29+37+19+3)=12

or from the stocks

Surplus=20+3−2+1+40+7−49−8=12

By moving negative numbers to the right hand side of the equation we get

Balance=20+3+1+40+7=12+49+2+8=71

assets=liabilities

The ass ts=liabilities condition follows from axiom No. 1 (th currency is conserved).

FIG. 6 shows the graph or network diagram in FIG. 5 drawn and calculated by a processing system according to the present invention. It is the same system or network as in FIG. 5. On the screen, knowns are green and unknowns are red. As opposed to paper in black and white print, it is easy to tell whether the model is in hindcast or forecast mode, and to see the variable setting (dependent or independent).

The hindcast mode is the calibration and budget simulation mode. Switching to the forecast mode, all flows in FIG. 6 turn dependent, except X0,1. They are functions of X0,1 in addition to the key ratios listed in the white background area to the left of the graph in FIG. 6.

A user may choose a step size by which he can down- or up-step the independent variables and immediately see the result in terms of dependent variables that change in such a way that the balance equations are never violated. The key ratios in analysis of financial accounts have so far been passive players. Now they are ‘active’, i.e. input to the model, making them options in financial and environmental management.

This facility is believed to be a new thing in accounting in contrast to prediction or budget simulation in hindcast mode, which already exist—based on the debit-credit method.

Additional Examples

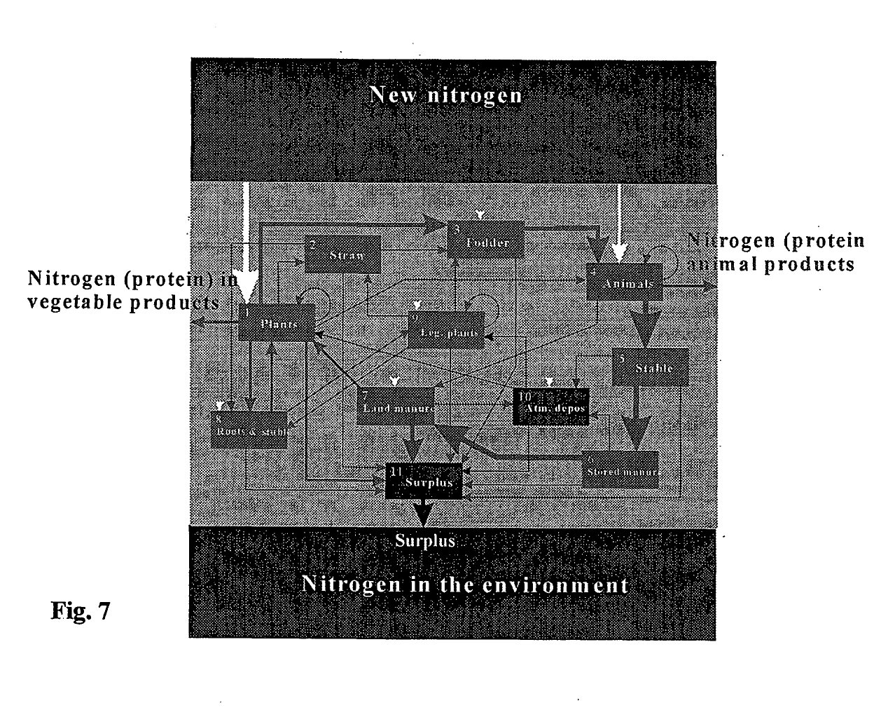

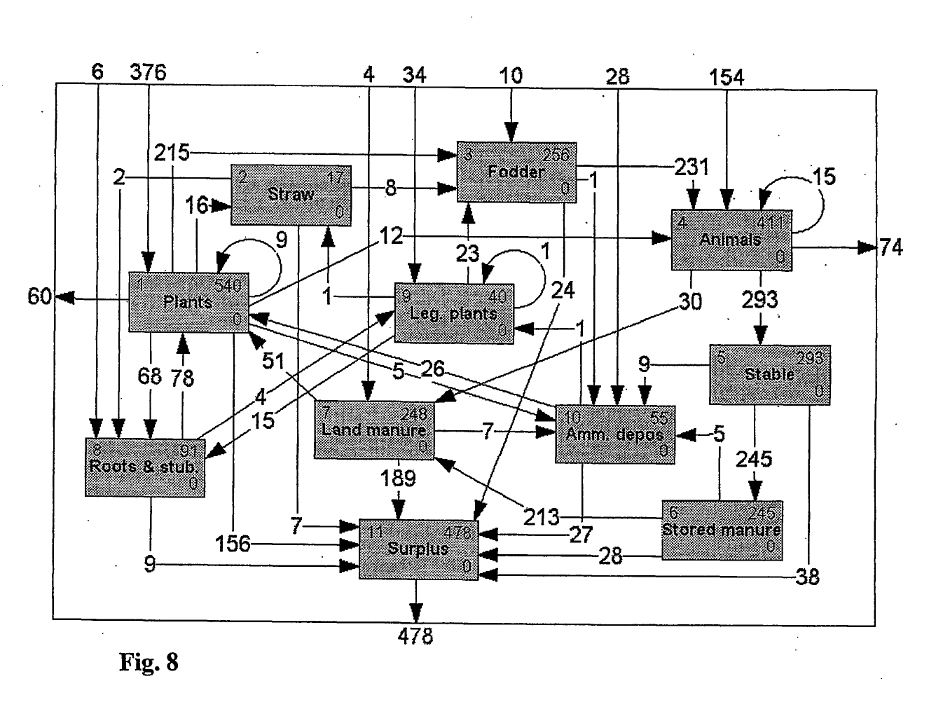

It also appears to be a new thing in accounting that one, in a single processing system, can unify financial and environmental accounting understood as accounting for energy or materials. In environmental management, the forecast mode is indispensable. As an example consider the nitrogen cycle of agriculture shown in FIG. 7. Nitrogen losses from agriculture is the subject of some concern because of rising levels of nitrate in ground water and eutrophication of lakes and open seas. In the same format as FIG. 7, FIG. 8 shows the nitrogen account of Danish agriculture in Mkg N per annum in the middle of the 1980ies. This account is based on statistical data on flows of agricultural goods multiplied by their nitrogen content and added over all goods in the flow.

Having calibrated the model in hindcast mode, we can shift to forecast and obtain a model allowing us to step up or down inputs of new nitrogen or key ratios of which the most important are ratios defining efficiencies. For instance, the nitrogen account in FIG. 8 is primarily a function of three efficiencies: 1) the plants' nitrogen uptake efficiency, 2) the fodder efficiency and 3) the fertiliser efficiency of nitrogen in manure.

The nitrogen management model can readily b applied to investigate what it takes in terms of a) reducing the input of new nitrogen and b) increasing the subsystems' efficiencies to obtain a certain balance. If, for instance, the goal were to reduce the output of nitrogen to the environment by 50 percent over a period of 10 years, and at the same time increase the agricultural production output by 2 percent p r annum, the software system can be applied to calculate the combination of input of new nitrogen and the key ratios that meet these simultaneous goals.

The nitrogen model is essentially capable of answering questions of the type: What happens if . . . ?

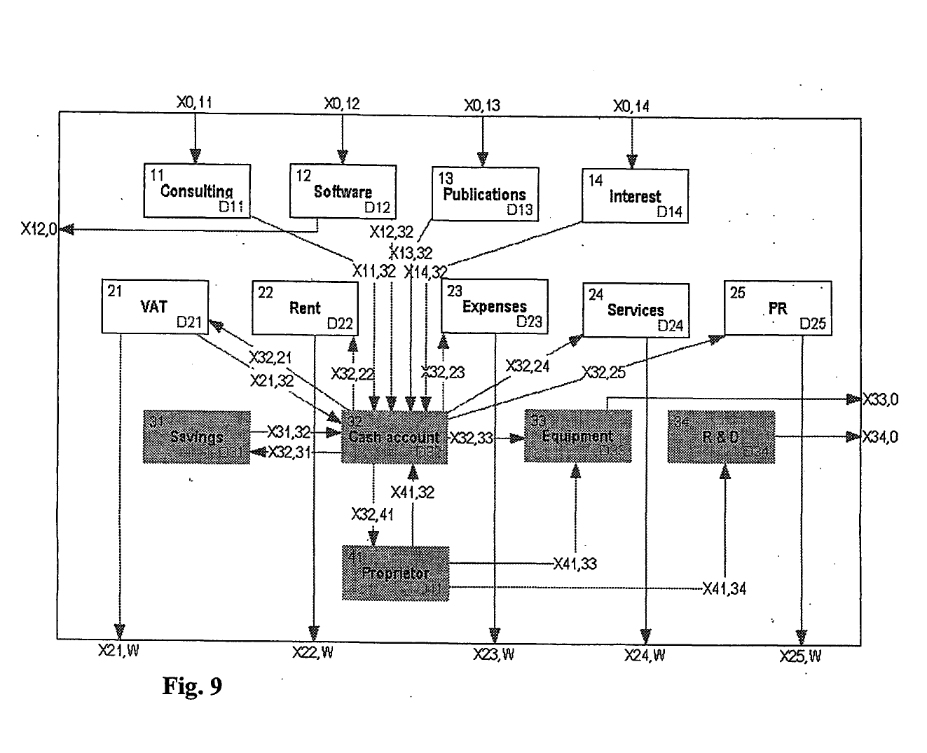

To complete this general description of a processing system according to the present invention, two additional visual accounts are included. FIG. 9 shows the account plan for a company selling counselling and software. Note that the account numbers are ordered so that the first digit is 1, 2, 3, or 4, the number of the four categories (rows) of accounts listed to the right of the graph in FIG. 5.

A R&D account, an intangible asset, is included. A knowledge asset is not a conserved quantity and can for that reason not be dealt with by double entry bookkeeping. But nothing prevents us from recording the asset as the amount actually spent on R&D.

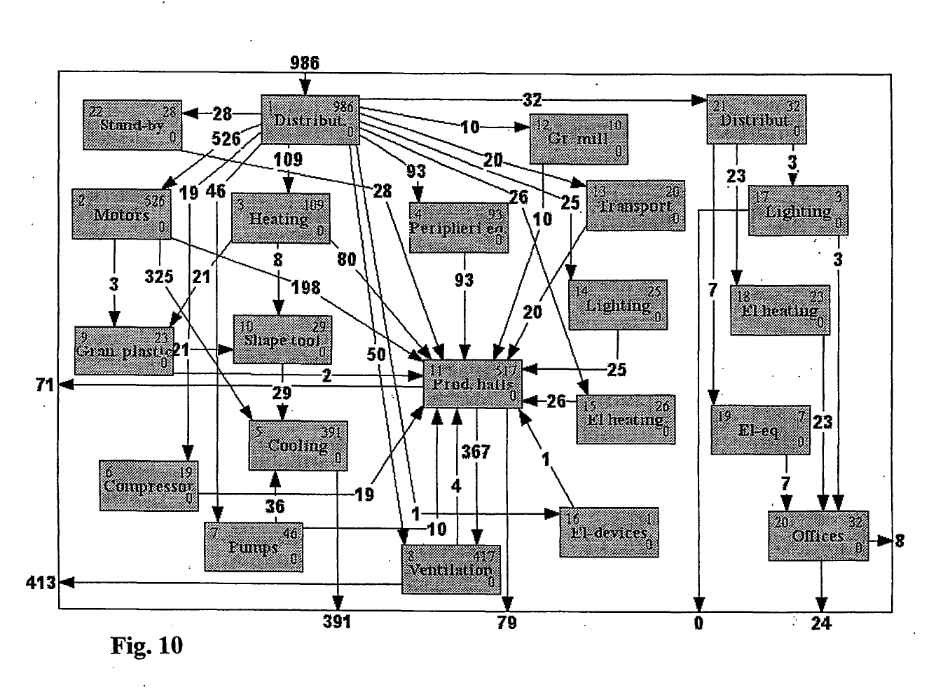

The method and the software system apply to the economy of a nation as well as, for instance, the energy account of a small manufacturing company. FIG. 10 shows the energy account in 1000 kWh per annum for a company producing plastic devises. In this case, the input-output model is calibrated by applying a mixture of empirical key ratios and recorded flows of electric energy.

The remaining text concerns details of preferred embodiments of algorithms used for calculation of dependent variables according to the present invention. As an introduction, the issue of the key ratio equations is dealt with below with some overlap to what has already been stated.

Default Key Ratio Equations (Forecast)

In hindcast we have key ratios as dependent variables and key ratio definitions, while in forecast we have key ratios as independent variables and key ratio equations. A processing system according to the present invention may continually maintain a set of default key ratio equations, examples of which are shown to the left of the graph in FIGS. 1, 6, 17 and 18.

Each subsystem has a set of key ratio equations attached to it, the number of which depends on the number of dependent variables attached to subsystem in question. For instance, a subsystem with one input (X0,1=100), and one output (X1,0=dependent), and a stock (D1=10), requires no k y ratio equation, since a balance equation is sufficient to calculate the dependent variables for this subsystem:

X1,0=X0,1−D1=100−10=90

If we add a flow (X1,W=dependent), we have two dependent variables, and since we need as many equations as we have dependent variables, we need one equation in addition to the balance equation. So, the processing system may now set up a default key ratio equation.

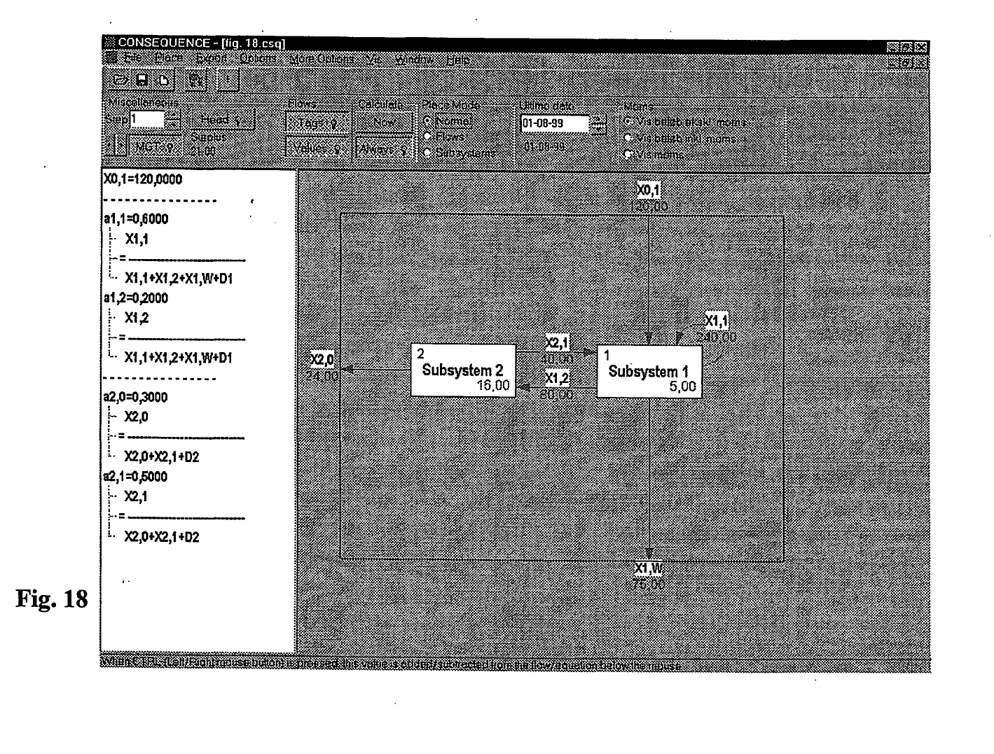

In forecast, the number of default key ratio equation for a subsystem is the number of dependent variables attached to that subsystem less one. For instance, subsystem 1 in FIG. 18 has three dependent variables (X1,1; X,2; X1,W) and two key ratio equations (a1,1; a1,2). Subsystem 2 in FIG. 18 has three dependent variables (X2,0; X2,1; D2) and two key ratio equations (a2,0; a2,1). Note that subsystem 1 has a key ratio for each output less one since the stock is an independent variable in that subsystem. Note likewise that subsystem 2 has a key ratio equation for each out-put, since the stock is a dependent variable in this subsystem.

A default key ratio definition or equation is an output coefficient:

$$ai , j = \frac{Xi , j}{{\sum }_{k = 1 , 2 … W}^{} Xi , k + Di}$$

where i is the number of the current subsystem, j is the number of the subsystem to which the output goes. Xi,j is a flow, from subsystem i into subsystem j, and Di is the stock in the subsystem. The denominator is the sum of all outputs from the subsystem plus the stock contained in it.

An example of a default key ratio equation (from FIG. 18) is:

$$a1 , 2 = \frac{X1 , 2}{X1 , 1 + X1 , 2 + X1 , W + D1}$$

Whenever the user connects/disconnects a flow or subsystem, or changes the stock setting (either flow or stock account) for a subsystem, the processing system of the present invention may correct the equations attached to that subsystem. For instance, if the user adds a flow from subsystem 1 into System 0 (to the right in FIG. 18), the processing system may add X1,0 to the denominator of the equation as follows:

$$a1 , 2 = \frac{X1 , 2}{X1 , 0 + X1 , 1 + X1 , 2 + X1 , W + D1}$$

Likewise, the processing system may add X1,0 to the denominator of equation a1,1 in FIG. 18. And since we now have one more dependent variable for the subsystem, the processing system may set up an additional default key ratio equation:

$$a1 , 0 = \frac{X1 , 0}{X1 , 0 + X1 , 1 + X1 , 2 + X1 , W + D1}$$

If the user deletes the flow X1,0 again, all the above changes will be reversed. Likewise, if the flow X1,2 in FIG. 18 were deleted, the processing system may remove X1,2 from the denominator of all default key ratio equations for subsystem 1, and remove the default key ratio equation a1,2.

The processing system may have a fixed order in which default key ratio equations are set up:

a1,0; a1,1; a1,2; a1,3 . . . a1,n; a1,W

That is, the processing system may set up a default key ratio equation for X1,0 if the flow exists, else it will try the flow X1,1 and so forth, until it has the number of key ratio equations required.

Custom Key Ratio Equations

A custom key ratio equation is a user-defined key ratio. The user can modify the numerator and denominator of key ratio definitions or equations. The numerator and the denominator must be conform to the following format

T1+T2+T3+ . . . +Tn

where T can be a flow, for instance X1,0, or a stock, for instance D2. T can be an independent or a dependent variable. In forecast at least one variable must be dependent.

When a key ratio equation has been modified, a processing system according to the present invention may stop maintaining it. So, after editing the network diagram, the user must update the modified (custom) key ratio equations affected by the changes.

A key ratio equation is linked to an (existing) output from a subsystem. For example a1,2 is linked to the flow X1,2. This link is remained even when the user modifies a default key ratio equation. That is, if a user has modified a2,0 in FIG. 18, and later deletes X2,0, the processing system of the present invention may delete the a2,0 key ratio equation. So, for a2,0 to exist there must be a flow X2,0, but X2,0 need not at all be present in the numerator of the user modified key ratio.

In order to produce a solution, the system of linear equations must meet certain conditions:

1. The matrix of coefficients must be quadratic, which is another way of saying that the number of dependent variables must equal the number of equations. In forecast, the number of equations is equal to the number of subsystems (equal to the number of balance equations) plus the number of key ratio equations.

2. The equations must be non-contradictory

3. The equations must be non-identical

The two last conditions are always met as far as the balance and the default key ratio equations are concerned. What remains to be considered are the custom (user-defined) key ratio equations. If a user does not comply with condition no. 2, for example by entering two equations each containing only one and the same dependent variable, the processing system “refuses” to solve the equations and may return this message: “Calculation failed in function linear equation solver”, meaning that there is no solution to the given set of equations. The same thing happens if a user by accident enters the same equation twice.

Consider the system in FIG. 1. In forecast there is only one custom key ratio equation to be defined. To be an equation it must contain at least one dependent variable, say x. If the user adds another flow, for example X1,0, the processing system may list a second default key ratio and invites the user to customise it. The user then cannot let it contain x as the only dependent vary able since that would violate either condition no. 2 or 3. A user can only involve x in the second key ratio equation if he lets Kt contain an additional dependent variable. If he chooses not to involve x in the second equation then it suffices to involve a different (a second) dependent variable. Hence, two custom key ratio equations involve at least two different dependent variables.

In general: if a user decides to define y key ratios (enter y custom key ratio definitions) then they must involve at least y different dependent variables, which can be any group of y variables taken from the group “dependent variables”. Each equation involves at least one dependent variable. In a subset of two or more equations, which contain only one dependent variable the same variable can appear once only.

A user never violates condition no. 1 and in practice rarely conditions nos. 2 and 3. In the unlikely event that he does, the processing system returns no solution.

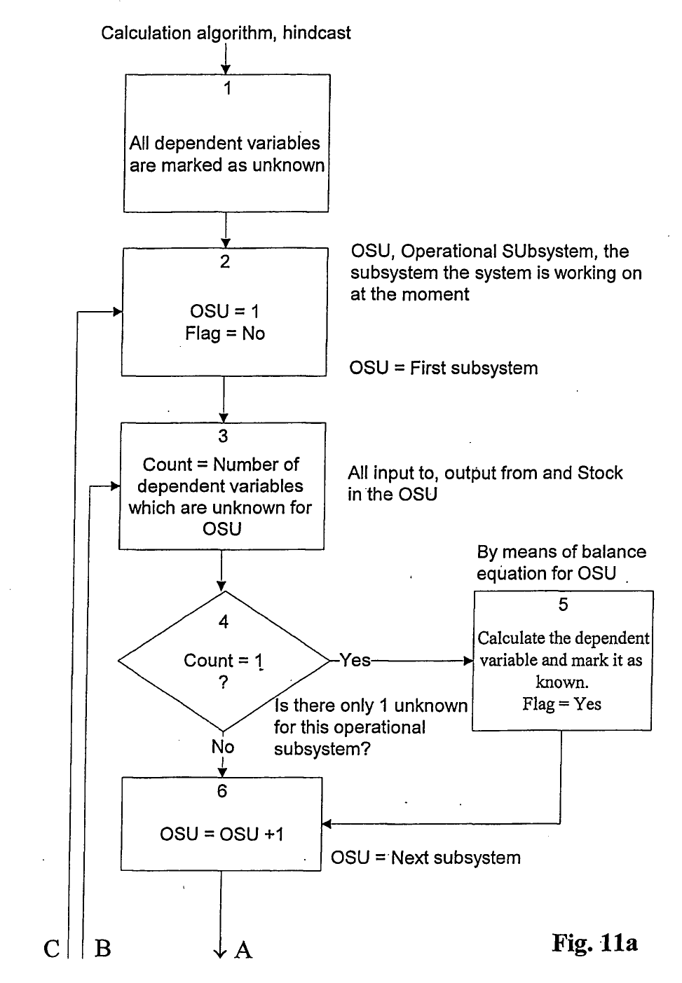

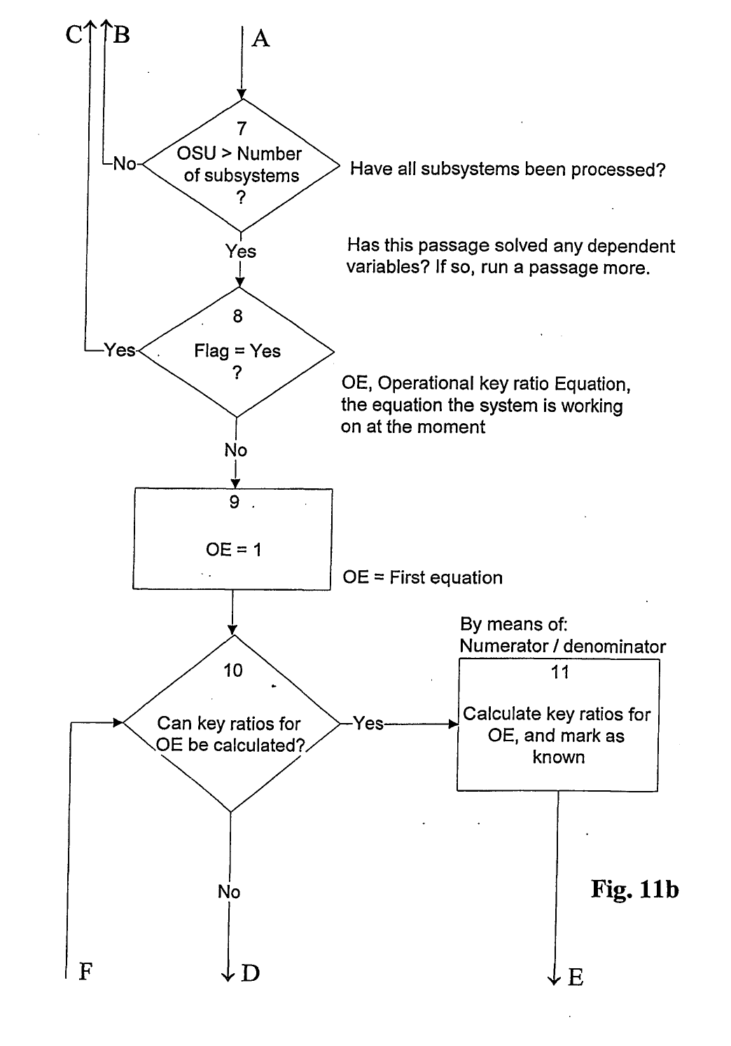

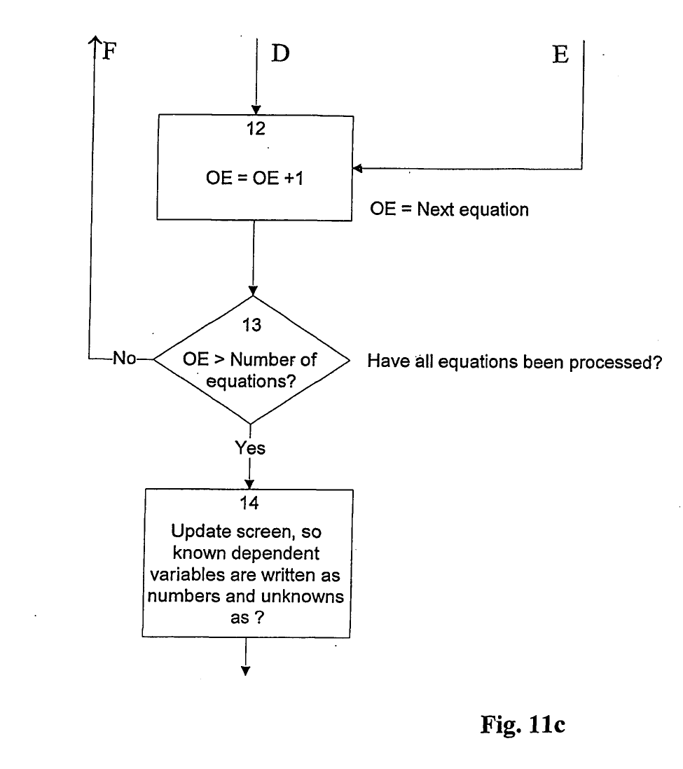

The Alg rithms (FIGS. 11-18)

When a user cr ates and edits a graph, for example

changes th value of a flow

changes the value of a stock

changes the value or the definition of a key ratio

adds or deletes a flow

adds or deletes a subsystem

then an embodiment of a processing system according to the present invention may operate a set of algorithms which calculate the dependent variables and make sure that the values displayed on the screen are valid, i.e. that the balance equations are never violated.

FIG. 11 Calculation algorithm, hindcast: This algorithm calculates the unknowns: flows, stocks and key ratios as functions of the knowns, i.e. other flows and stocks. The governing equations are the balance equation, one for each subsystem. The key ratios are subsequently calculated according to their definition simply by inserting the values (a mixture of knowns and unknowns) in the formula defining the key ratio. The algorithm can calculate the unknowns that are possible to calculate from the known variables given by the user. If, for example, the user has not quantified the known variables D1 and X1,5 then the unknown X0,1 cannot be calculated since the balance equations reads

D1=X0,1−X1,5

The unknowns that can be calculated may be marked as knowns (independent) internally in the processing system according to the present invention, the rest may be marked as unknowns (dependent). On the screen, knowns may be indicated by a figure and unknowns by a “?”.

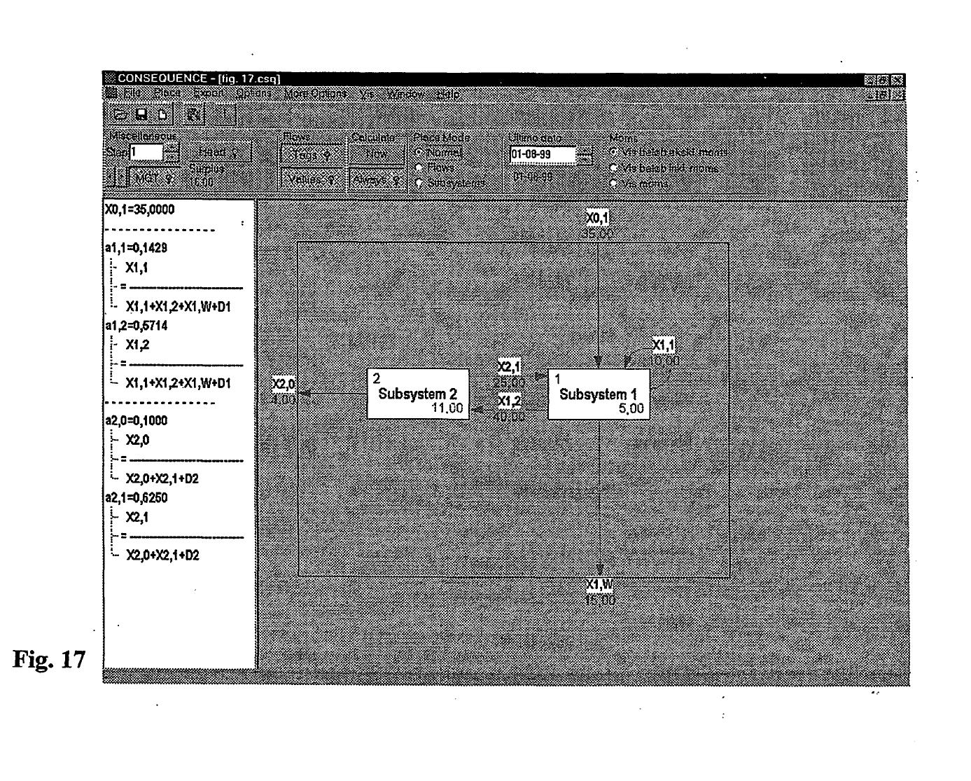

This flowchart shows how dependent variables are calculated in hindcast mode according to an embodiment of a processing system of the present invention. Reference is made to the graph in FIG. 17 in the following description.

Model input (independent variables):

Flows (FIG. 17: X0,1; X1,1; X1,W; X2,0; X2,1)

Stocks (FIG. 17: D1)

Model output (dependent variables):

Flows (FIG. 17: X1,2)

Stocks (FIG. 17: D2)

Key ratios (FIG. 17: a1,1; a1,2; a2,0; a2,1) The calculation is divided into 4 steps:

1) Box 1 on FIG. 11

All dependent variables are marked as ‘unknowns’, that is their values are cleared.

Each variable in the processing system may have two properties: A value and a status. If the processing system marks a variable as a dependent variable, it may actually set its status to dependent (unknown).

2) Box 2-8 on FIG. 11

The algorithm runs through the subsystems as many times as required to solve for the dependent variables (only flows and stocks, not key ratios in hindcast). The algorithm processes the subsystems one at a time. OSU=Operational SUbsystem is the subsystem the algorithm is working on at the moment. The algorithm starts with subsystem number 1, and continues with subsystem number 2 and so forth. In box 2 the algorithm sets the operational subsystem (OSU) to subsystem number 1. In box 3 the algorithm counts the number of dependent variables for the operational subsystem. The algorithm counts the number of dependent variables, because it can only solve the subsystem if there is only one dependent variable left to solve.

The actual calculation of a dependent variable is done by means of a balance equation (box 5). For instance the dependent variable X1,2 on FIG. 17 is calculated as follows:

X1,2=X0,1+X1,1+X2,1−X1,1−X1, W−S1=35+10+25−10−15−5=40

Box 6: The algorithm sets the operational subsystem to the next subsystem. In each passage (a passage is a run through all the subsystem) a flag is used to signal if a passage has solved for a dependent variable or not. If a passage has solved a dependent variable then Flag=Yes (box 5), the algorithm runs another passage. When a passage hasn't solved a dependent variable (Flag=No) the algorithm continues to box 9.

Sometimes many passages are required to solve all the dependent variables possible since the solving of a d pendent variable may require that another dependent variable is solved before-hand.

Box 7 controls the loop that runs through the subsystems one at a time.

Box 8 controls the loop that runs until the loop controlled by box 7 hasn't solved any dependent variables.

3) Box 9-13 on FIG. 11

This part of the algorithm runs through the key ratio equations one at a time, and checks if it is possible to calculate the key ratio. If it is possible to calculate a key ratio it does so, for instance, the first key ratio equation on FIG. 17 is

a,1,1=X11/X1,1+X1,2+X1, W+D1

and the key ratio a1, 1 is calculated as follows (box 11 on FIG. 11)

a1,1=10/10+40+15+5=10/70=0,1429

Box 9: The algorithm sets the operational key ratio equation to key ratio equation number 1 (the topmost key ratio equation to the left of the graph in FIG. 17).

Box 12: The algorithm sets the operational key ratio equation to the next key ratio equation.

Box 13 controls the loop that runs through the key ratio equations one at a time.

Box 10: The algorithm checks if a key ratio can be solved which is done by testing all the variables in the numerator and denominator of the operational key ratio equation; if all variables are known, the key ratio can be calculated.

4) Box 14 on FIG. 11. Update Screen.

The screen is updated with the calculated dependent variables, and with ‘?’ where the calculation was unsuccessful.

in FIG. 17 the following dependent variables are calculated:

X1,2; a1,1; a1,2

In FIG. 17 the following dependent variables could not b calculated, since the user has not entered a value for X2,0:

D2; a2,0; a2,1

Note: All values are calculated every time the calculation algorithm runs.

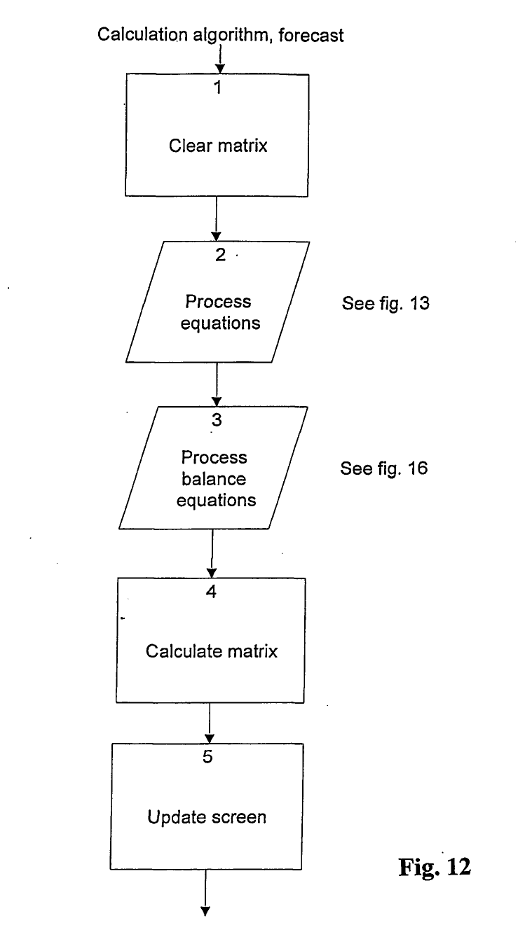

FIG. 12 Calculation algorithm, forecast: This algorithm calculates the unknowns: output flows and stocks as functions of key ratios and knowns i.e. other stocks and inputs from the exterior. The calculation is either successful in terms of finding a solution or not. If it is successful then the solution is shown in terms of quantified flows and stocks on the graph. The algorithm sets up the quadratic coefficient matrix A and the column vector (y) composed of knowns on the right hand side of the equation:

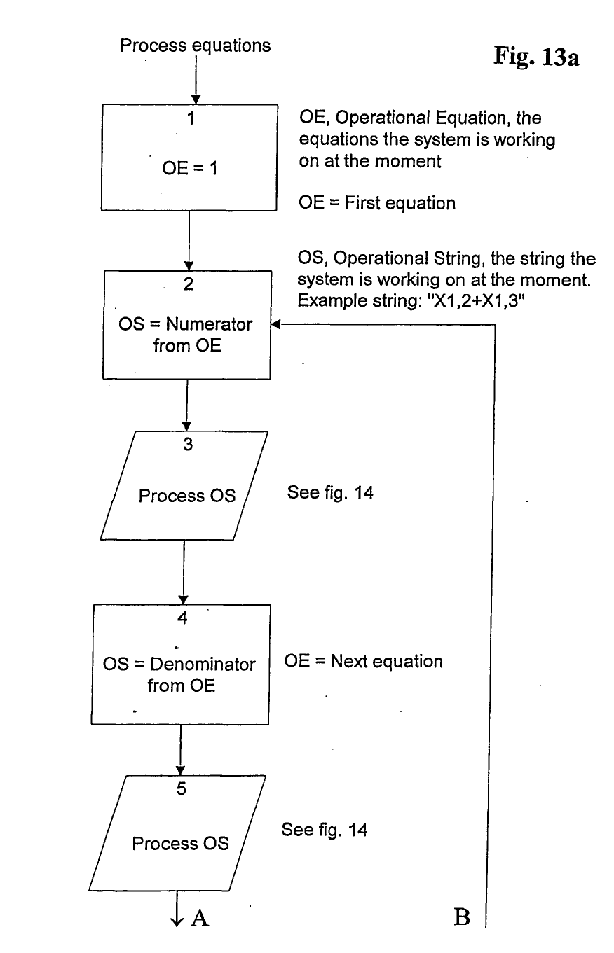

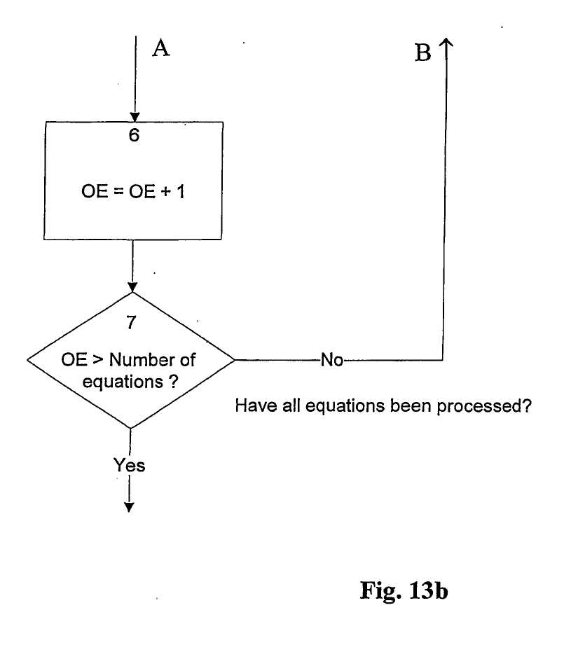

A*x=y

in which x is the solution vector. In the following diagrams (FIGS. 13-16) the notation MA[i,j] is used for A and MB[i] for y, thus

MA[i,j]*x=MB[i]

The flowchart shows how dependent variables are calculated in forecast mode according to a preferred embodiment of the present invention. The graph shown in FIG. 18 will be used as reference in the following description.

Model input (independent variables):

Flows (FIG. 18: X0,1)

Stocks (FIG. 18: D1)

Key ratios (FIG. 18: a1,1; a1,2; a2,0; a2,1)

Model output (dependent variables):

Flows (FIG. 18: X1,1; X1,2; X1,W; X2,0; X2,1)

Stocks (FIG. 18: D2)

See description of MA & MB matrixes, and the explanation of how the matrixes are calculated.

The calculation is divided into 5 steps:

1) Box 1 on FIG. 12

The algorithm clears the matrixes (MA, MB) applied to calculate the dependent variables.

2) Box 2 on FIG. 12. Process equations.

In FIG. 18 the first key ratio equation is

a1,1=X1,1/(1,1+X1,2+X1,W+D1)

and there are 4 key ratio equations to process, see FIG. 13 and the corresponding description.

The algorithm runs through the key ratio equations and updates the matrixes MA, MB as required to calculate the dependent variables in box 4, FIG. 12.

3) Box 3 on FIG. 12. Process Balance Equations.

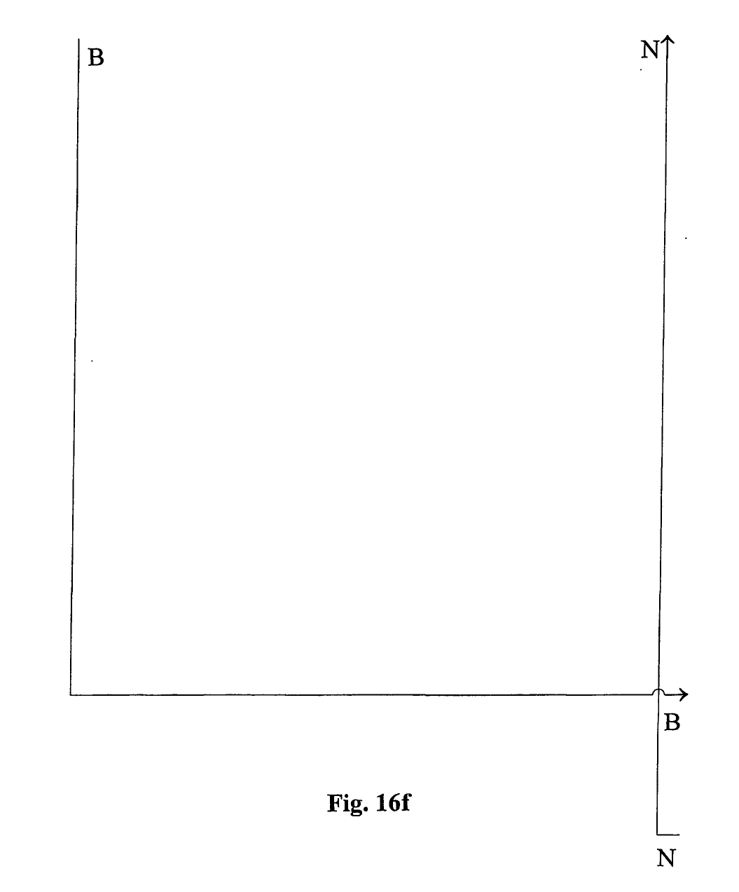

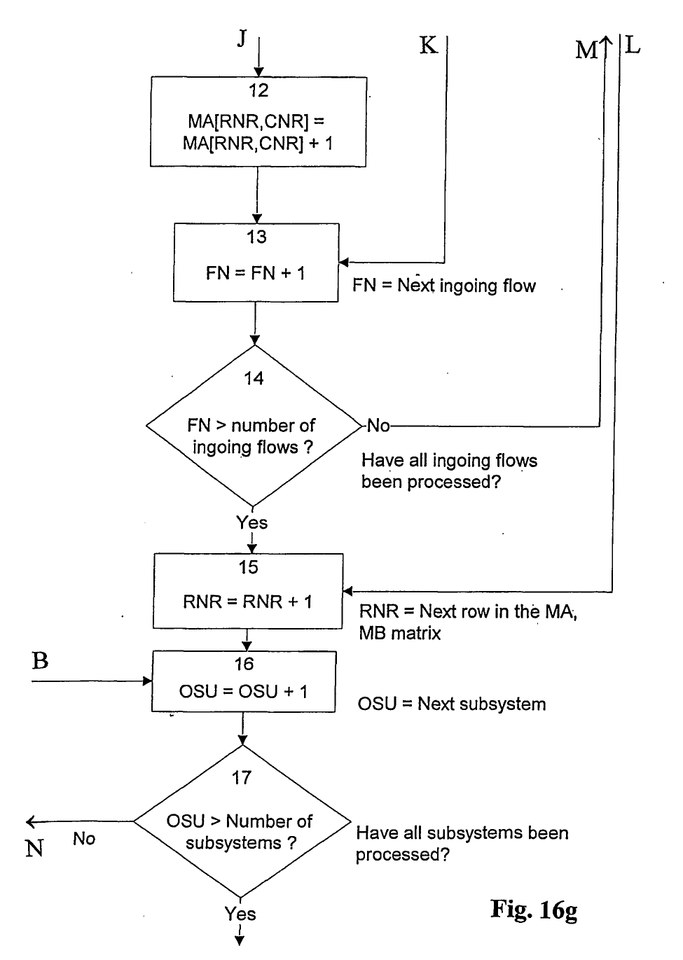

The algorithm runs through the subsystems and sets up a balance equation for each subsystem, see FIG. 16 and the corresponding description.

The balance equation is used to update the matrixes MA, MB as required to calculate the dependent variables in box 4, FIG. 12.

4) Box 4 on FIG. 12. Calculate Matrix.

The solution matrix is calculated as MB/MA, see description elsewhere.

5) Box 5 on FIG. 12. Update Screen.

If the calculation is successful, the values of the dependent variables are displayed on the screen. If the calculation fails, question marks (?) are shown instead.

Note: All values are calculated every time the calculation algorithm runs.

FIG. 13 Process equations: This algorithm is part of ‘Calculation algorithm, forecast’ (see FIG. 12). The graph shown in FIG. 18 will be used as reference in the following description.

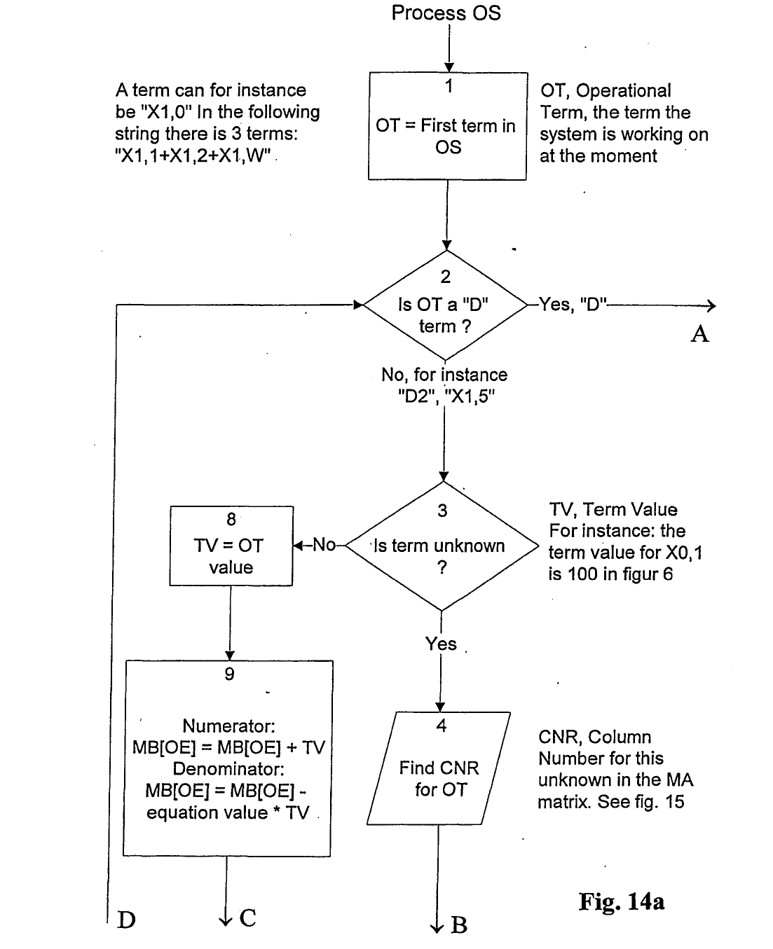

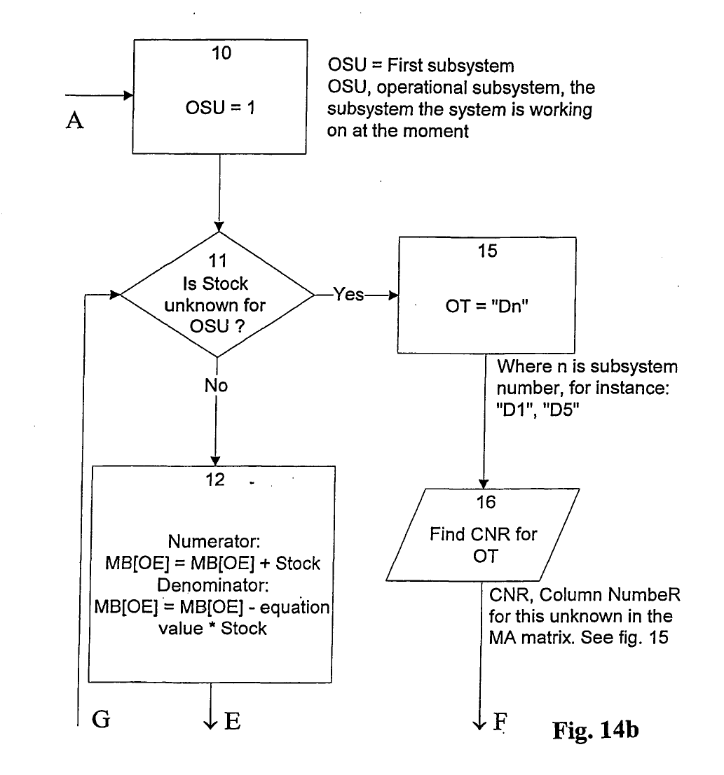

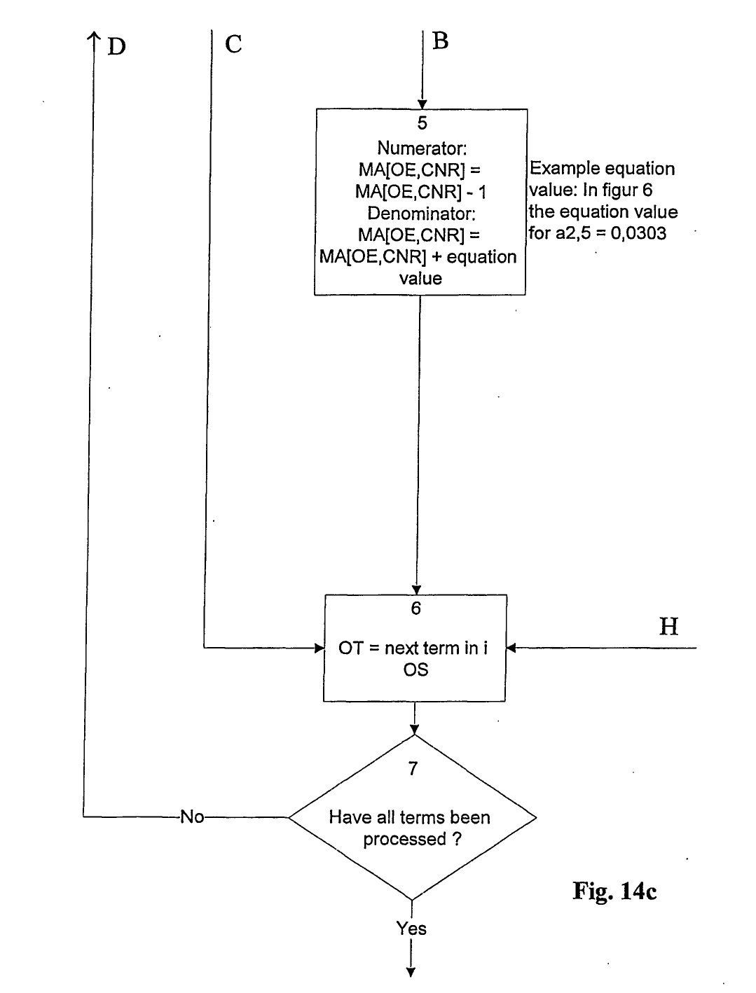

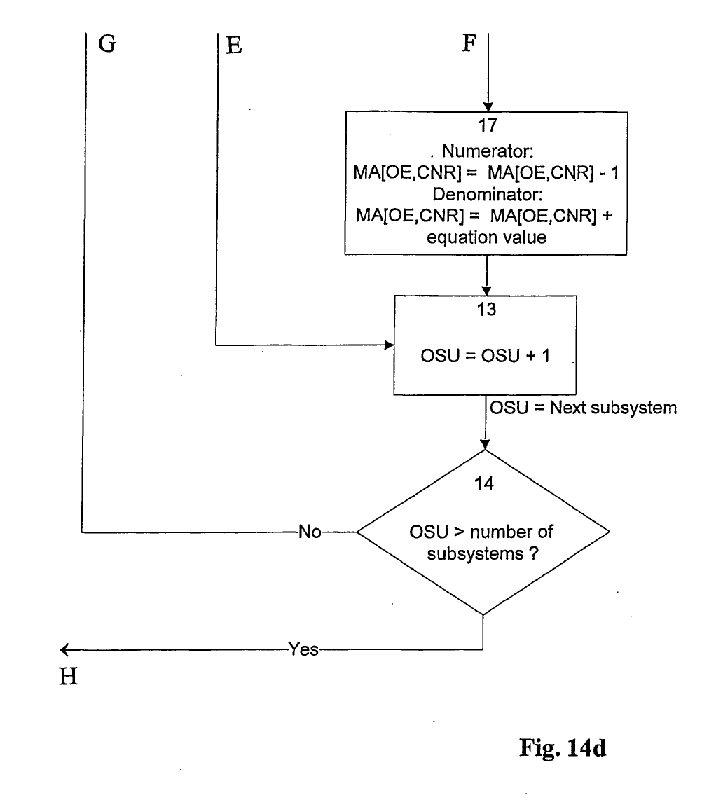

This algorithm runs through the key ratio equations (for instance 4 equations in FIG. 18), and calls an algorithm, ‘Process OS’ (see FIG. 14) for ach numerator and denominator. For instance:

When this algorithm processes the key ratio equations in FIG. 18, it will first call ‘Process OS’ with the string ‘X1,1’, and then ‘X1,1+X1,2+X1,W+D1’, and then ‘X1,2’, and then . . . .

FIG. 14 Process OS: ‘Process OS’ updates the matrixes MA, MB as required to calculate the dependent variables in box 4, FIG. 12.

In FIG. 14, OS stands for Operational String, which is the string on which the embodiment of the processing system of the present invention operates at the moment, for instance “X1,0+X1,1+X1, W”. OE stands for Operational Equation, which is the equation on which the embodiment of the processing system operates at the moment.

This algorithm is part of ‘Calculation algorithm, forecast’ (see FIG. 12). The graph shown in FIG. 18 will be used as reference in the following description. This algorithm runs through an input string, term by term and updates the matrixes MA, MB as required to calculate the dependent variables in box 4, FIG. 12.

The input string could for instance be the denominator from key ratio equation 2 in FIG. 18

‘X1,1+X1,2+X1,W+D1’.

This string has 4 terms, which are processed individually. See description of MA & MB matrixes, and the explanation of how the matrixes are calculated.

In some of the boxes stands “numerator” and “denominator”. For numerator the rule is that the subsequent mathematical operation is applied when the algorithm operates on a numerator of a key ratio equation. For denominator the rule is correspondingly that the subsequent mathematical operation is applied when the algorithm operates on a denominator of a key ratio equation.

Examples: ‘Process OS’ processes the term ‘X1,1’ (Numerator, first key ratio equation FIG. 18). X1,1 is a dependent variable, and the algorithm processes it in boxes 4-5 in FIG. 14. First it finds the column number for X1,1 in the MA matrix, then it subtracts 1 from the value in the MA matrix in row nr 1 (since this is the first key ratio equation). ‘Process OS’processes the term ‘D1’ (Denominator, first key ratio equation FIG. 18). D1 is a known variable, and the algorithm processes it in boxes 8-9 in FIG. 14. First it finds the term value for D1 (which is 10 in FIG. 18) and multiplies it with the key ratio (which is 0,6 in FIG. 18). This value (10*0,6=6) is subtracted from the value in the MB matrix in row nr 1 (since this is the first key ratio equation).

Before processing key ratio equation 1 from FIG. 18, the matrixes MA, MB will be all zero, as shown below:

$$\begin{matrix}MA & & & MB \\ X1 , 1 & X1 , 2 & X1 , W & \\ [ 0 & 0 & 0 ] & [ 0 ]\end{matrix}$$

When the first key ratio equation has been processed, the matrixes MA, MB will have the following values:

$$\begin{matrix}MA & & & MB \\ X1 , 1 & X1 , 2 & X1 , W & \\ [ - 0 , 4 & 0 , 6 & 0 , 6 ] & [ - 6 ]\end{matrix}$$

When the second key ratio equation has been processed, the matrixes MA, MB will have the following values:

$$\begin{matrix}MA & & & & MB \\ X1 , 1 & X1 , 2 & X1 , W & & \\ [ - 0 , 4 & 0 , 6 & 0 , 6 ] & [ - 6 ] & \\ [ 0 , 2 & - 0 , 8 & 0 , 2 ] & [ - 2 ] & \end{matrix}$$

When the third key ratio equation has been processed, the matrixes MA, MB will have the following values:

$$\begin{matrix}MA & & & & & & MB \\ [ X1 , 1 & X1 , 2 & X1 , W & X2 , 0 & X2 , 1 & D2 ] & \\ [ - 0 , 4 & 0 , 6 & 0 , 6 & 0 & 0 & 0 ] & [ - 6 ] \\ [ 0 , 2 & - 0 , 8 & 0 , 2 & 0 & 0 & 0 ] & [ - 2 ] \\ [ 0 & 0 & 0 & - 0 , 7 & 0 , 3 & 0 , 3 ] & [ 0 ]\end{matrix}$$

When the fourth key ratio equation has been processed, the matrixes MA, MB will have the following values:

$$\begin{matrix}MA & & & & & & MB \\ [ X1 , 1 & X1 , 2 & X1 , W & X2 , 0 & X2 , 1 & D2 ] & \\ [ - 0 , 4 & 0 , 6 & 0 , 6 & 0 & 0 & 0 ] & [ - 6 ] \\ [ 0 , 2 & - 0 , 8 & 0 , 2 & 0 & 0 & 0 ] & [ - 2 ] \\ [ 0 & 0 & 0 & - 0 , 7 & 0 , 3 & 0 , 3 ] & [ 0 ] \\ [ 0 & 0 & 0 & 0 , 5 & - 0 , 5 & 0 , 5 ] & [ 0 ]\end{matrix}$$

Now all we need to be able to calculate the dependent variables are the balance equations. See FIG. 16, where this exampl will be continued.

This algorithm is able to process a special term, ‘D’ (see box 10-17 in FIG. 14), which is the symbol for the sum of all the stocks in the graph. For instance, ‘D’ equals D1+D2‘in FIG. 18.

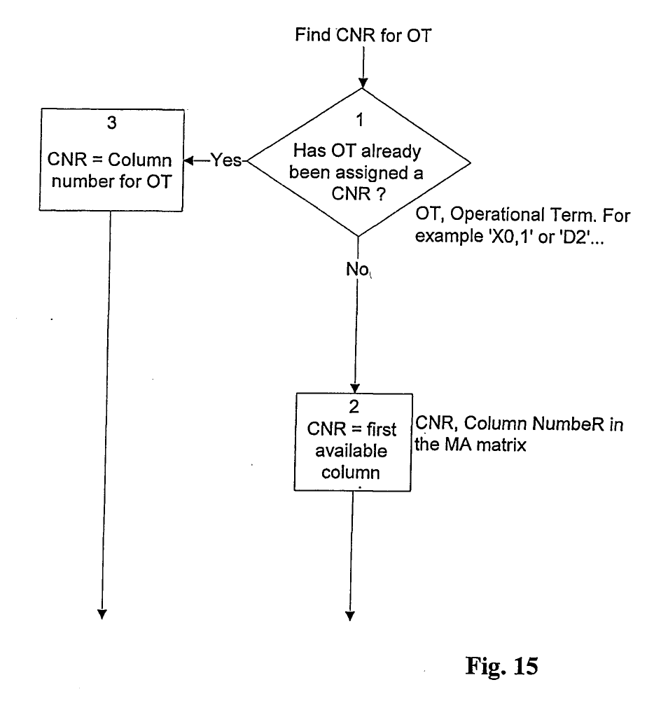

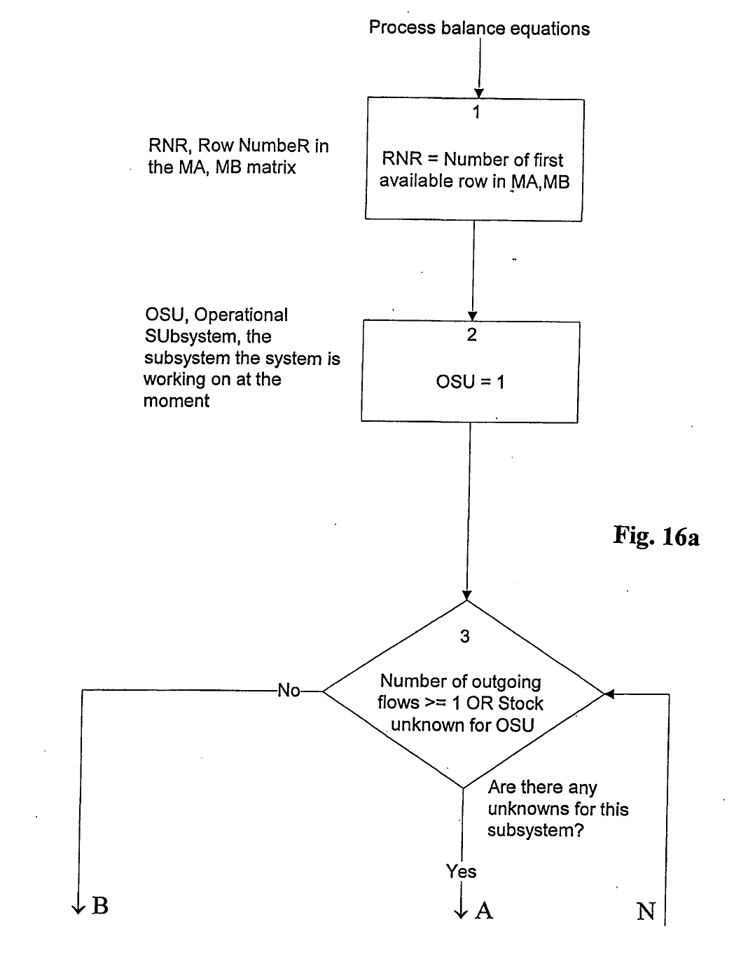

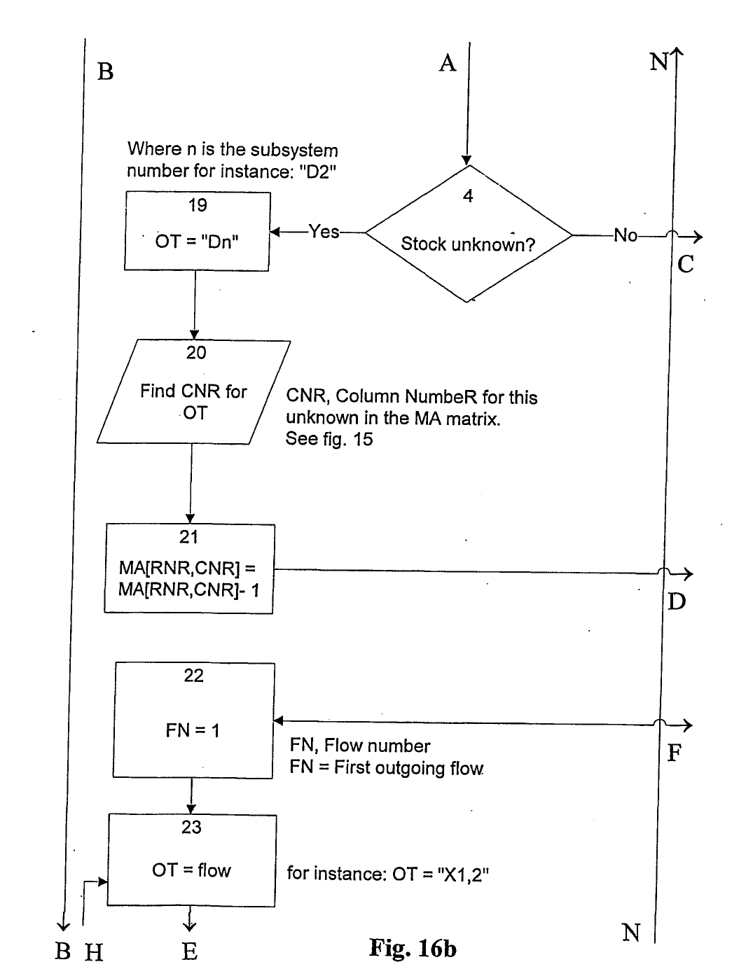

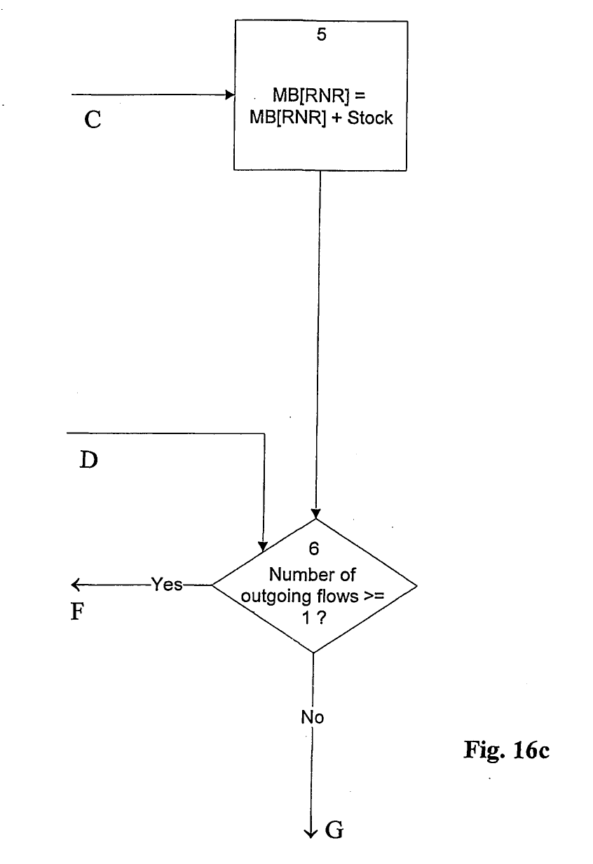

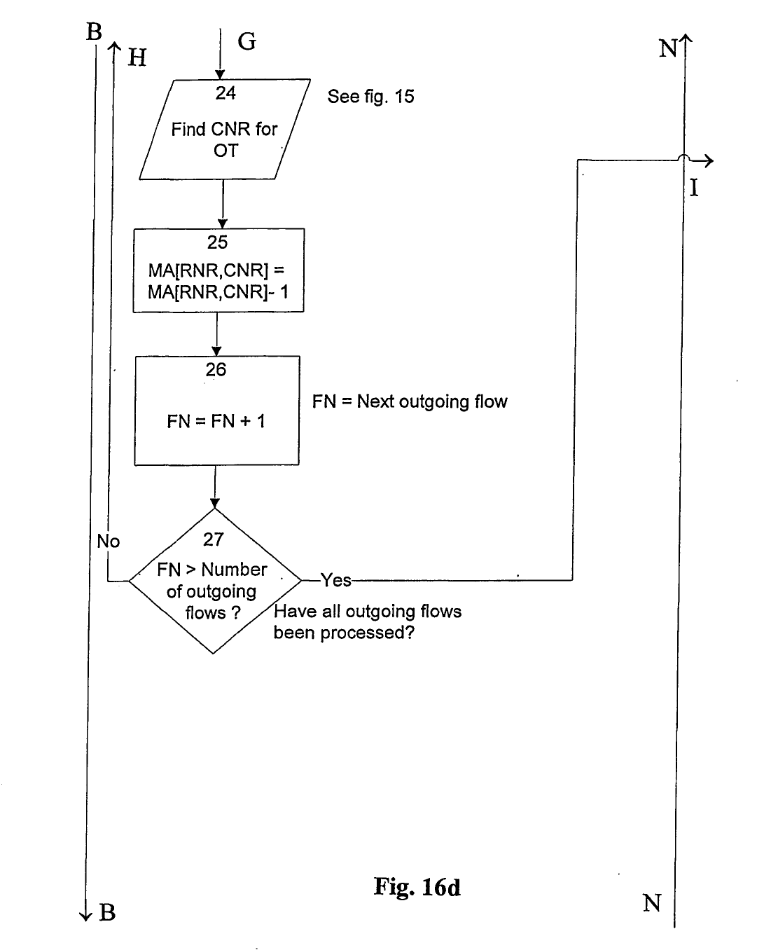

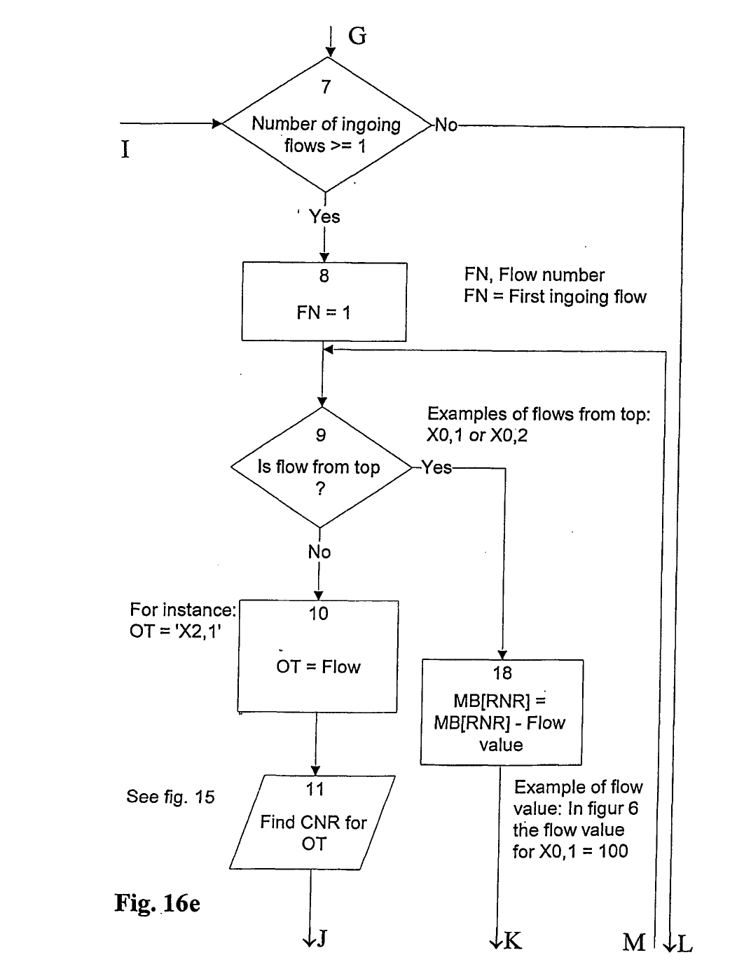

FIG. 15 Find CNR for OT: This algorithm is part of ‘Calculation algorithm, forecast’ (see FIG. 12). See description elsewhere.

In FIG. 15 (Algorithm: Find CNR for OT) CNR stands for Column NumbeR and OT for Operational Term, which is the term on which the algorithm in FIG. 15 is operating at the moment, for instance “X1,0”. CNR is a column number for OT. It is conducive to imagine the matrix MA as indicated below

$$\begin{matrix} MA \\ [ \begin{matrix}X 1 , 1 & X 1 , 2 & X 2 , 1 & ? & ?\end{matrix} ] MB \\ [ \begin{matrix}1.00 & 0.20 & 1.00 & 0 & 0 \\ 2.00 & 0.00 & 3.00 & 0 & 0 \\ 1.00 & 1.00 & 2.00 & 0 & 0 \\ 0.00 & 0.00 & 0.00 & 0 & 0\end{matrix} ] [ \begin{matrix}1 \\ 2 \\ 3 \\ 0\end{matrix} ]\end{matrix}$$

When the algorithm is applied to find a column number for an unknown, e.g. X1,2 it begins by checking whether the first column in MA contains X1,2. if it is not found, it proceeds to the next column and checks again. When it finds the column in which the unknown is present it uses this column. If not found, it continues checking columns until a “?” is reached. When that happens the algorithm “knows” that no column has been allocated for this unknown and therefore uses the “?” column and replaces the“?” by X1,2.

FIG. 16 Process balance equations: Again OT stands for Operational Term which is the term on which the embodiment of the processing system is operating at the moment. The balance equations are not actually set up by the embodiment of the processing system, instead the embodiment of the processing system runs through the subsystems and updates the matrixes as necessary.

In the first box shown in FIG. 16 the algorithm finds an available row in the matrices MA and MB. This is the first row with all zero values, for instance the last row in the matrix shown abov .

This algorithm is part of ‘Calculation algorithm, forecast’ (see FIG. 12). The graph shown in FIG. 18 will be used as reference in the following description.

This algorithm runs through the subsystems utilizing balance equations to update the matrixes MA, MB as required to calculate the dependent variables in box 4, FIG. 12. When running through the subsystems, it first checks if the subsystem has any dependent variables (box 3, FIG. 16). If not it moves to the next subsystem (box 16, FIG. 16).

If it has one or more dependent variables, the algorithm adds a row to the MA, MB matrix. Then the algorithm checks whether the stock for the current subsystem is a dependent variable (Box 4, FIG. 16). If the stock is unknown the algorithm finds the column number for this unknown in the MA matrix, and subtracts 1 from the value in the new row (box 19-21, FIG. 16). It the stock is known, the algorithm adds the stock value to the MB matrix in the new row (box 5, FIG. 16).

Then the algorithm runs through all outputs from the current subsystem. For each flow it finds the column number for it in the MA matrix, and subtracts 1 from the value in the new row (box 22-27, FIG. 16).

Next, the algorithm runs through all inputs to the current subsystem. If the current flow is from System 0 (for instance X0,1 or X0,2), then the algorithm subtracts the flow value from the MB matrix in the new row (box 18, FIG. 16). Flows from System 0 are always known variables. If the current flow is not from System 0, the algorithm finds the column number for the flow in the MA matrix, and adds 1 to the value in the new row (box 12, FIG. 16).

The subsystem is now processed and the algorithm moves on to the next subsystem.

Example continued from description of FIG. 14. Before processing any subsystems, the matrixes MA, MB will have the following values:

$$\begin{matrix}MA MB \\ [ X 1 , 1 X 1 , 2 X 1 , W X 2 , 0 X 2 , 1 D2 ] \\ [ \begin{matrix}- 0 , 4 & 0 , 6 & 0 , 6 & 0 & 0 & 0 & ]\end{matrix} [ - 6 ] \\ [ \begin{matrix}0 , 2 & - 0 , 8 & 0 , 2 & 0 & 0 & 0 & ]\end{matrix} [ - 2 ] \\ [ \begin{matrix}0 & 0 & 0 & - 0 , 7 & 0 , 3 & 0 , 3 ]\end{matrix} [ 0 ] \\ [ \begin{matrix}0 & 0 & 0 & 0 , 5 & - 0 , 5 & 0 , 5 ]\end{matrix} [ 0 ]\end{matrix}$$

After processing subsystem 1 from FIG. 18, the matrixes MA, MB will have the following values:

$$\begin{matrix}MA MB \\ [ X 1 , 1 X 1 , 2 X 1 , W X 2 , 0 X 2 , 1 D2 ] \\ [ \begin{matrix}- 0 , 4 & 0 , 6 & 0 , 6 & 0 & 0 & 0 & ]\end{matrix} [ - 6 ] \\ [ \begin{matrix}0 , 2 & - 0 , 8 & 0 , 2 & 0 & 0 & 0 & ]\end{matrix} [ - 2 ] \\ [ \begin{matrix}0 & 0 & 0 & - 0 , 7 & 0 , 3 & 0 , 3 ]\end{matrix} [ 0 ] \\ [ \begin{matrix}0 & 0 & 0 & 0 , 5 & - 0 , 5 & 0 , 5 ]\end{matrix} [ 0 ] \\ \begin{matrix}[ 0 & - 1 & - 1 & 0 & 1 & 0 ]\end{matrix} [ - 110 ]\end{matrix}$$

After processing subsystem 2 from FIG. 18, the matrixes MA, MB will have the following values:

$$\begin{matrix}MA MB \\ [ X 1 , 1 X 1 , 2 X 1 , W X 2 , 0 X 2 , 1 D2 ] \\ [ \begin{matrix}- 0 , 4 & 0 , 6 & 0 , 6 & 0 & 0 & 0 & ]\end{matrix} [ - 6 ] \\ [ \begin{matrix}0 , 2 & - 0 , 8 & 0 , 2 & 0 & 0 & 0 & ]\end{matrix} [ - 2 ] \\ [ \begin{matrix}0 & 0 & 0 & - 0 , 7 & 0 , 3 & 0 , 3 ]\end{matrix} [ 0 ] \\ [ \begin{matrix}0 & 0 & 0 & 0 , 5 & - 0 , 5 & 0 , 5 ]\end{matrix} [ 0 ] \\ \begin{matrix}[ 0 & - 1 & - 1 & 0 & 1 & 0 ]\end{matrix} [ - 110 ] \\ \begin{matrix}[ 0 & 1 & 0 & - 1 & - 1 & - 1 ]\end{matrix} [ 0 ]\end{matrix}$$

Now the equations can be solved by matrix calculations:

[X1,1 X1,2 X1,W X2,0 X2,1 D2]=[240, 80, 70, 24, 40, 16]

These values are shown on FIG. 18.

FIG. 17 shows an example of a balanced system in a hindcast mode according to an embodiment of the present invention, and FIG. 18 shows an example of a balanced system in a forecast mode according to an embodiment of the present invention. The systems of FIGS. 17 and 18 have default key ratio equations, that is key ratio equations set up according to an embodiment of a processing system of the present invention. The system FIG. 17 is discussed in connection with the flow chart of FIG. 11, while the system of FIG. 18 is discussed in connection with the flow charts of FIGS. 12-16.

While the invention has been particularly shown and described with reference to particular embodiments, it will be understood by those skilled in the art that various changes in form and details may be made therein without departing from the spirit and scope of the invention, and it is intend d that such changes com within the scope of the following claims.

1. A computer system for processing and display of variables in a user gen rated network diagram representing a balanced system, said variables representing stocks and flows of resources and key ratios being ratios of linear combinations of flows and/or stocks of resources, said system comprising:
a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources into or from a subsystem,
means for assigning all output flows of resources from each subsystem as dependent variables,
a user interface for assigning the stock of resources contained in each subsystem as a dependent or an independent variable,
means for assigning all flows of resources from the giving system into a node in the network as independent variables,
means for generating and/or user-defining, for each subsystem, a number of key ratio equations, each said key ratio equation consisting of a key ratio being an independent variable set equal to a fraction or a ratio with a linear combination of flows and/or stocks in the numerator and another linear combination of flows and/or stocks in the denominator, said number of key ratio equations being equal to the number of dependent variables assigned to said subsystem minus one,
a user interface for entering numerical values of some or all of the independent variables, and
means for calculating numerical values of some or all of the dependent variables based on values of the independent variables.

2. A system according to claim 1, said system being adapted for displaying ntered values of independent variables and calculated values of dependent variables.

3. A system according to claim 1 or 2, wherein said means for calculating the values of the dependent variables is adapted for g nerating, for each subsystem, a balance equation, said balance equation stating the balance: flows of resources into the subsystem minus flows of resources out of the subsystem equals the stock of resources contained in the subsystem.

4. A system according to claim 3, wherein said means for calculating the dependent variables is adapted for performing said calculation based on balance equations and key ratio equations.

5. A system according to claim 4, wherein the means for calculating the dependent variables is adapted for performing said calculation based on a set of (n+m) simultaneous linear equations, where n is equal to the number of subsystems in the network, and thereby to the number of balance equations, and m is equal to the sum of the minimum required number of key ratio equations for each subsystem.

6. A system according to any of the claims 1-5, wherein the means for generating the key ratio equations is adapted for generating m default key ratio equations, where m is equal to the sum of the minimum required number of key ratio equations for each subsystem.

7. A system according to any of the claims 1-6, wherein the means for system-generating and/or user-defining key ratios comprises a user interface for entering user-defined key ratio equations.

8. A system according to claim 6 or 7, wherein the means for generating a default key ratio equation is adapted for generating key ratio equations having a numerator given by a single output flow from the corresponding subsystem.

9. A system according to claim 8, wherein the means for generating a default key ratio equation is adapted for generating key ratio equations so that all generated key ratio equations have a numerator given by a single output flow from the corresponding subsystem.

10. A system according to any of the claims 6-9, wherein the means for generating a default key ratio equation is adapted for generating key ratio equations having a denominator given by the total flow output from the corresponding subsystem plus the stock of the corresponding subsystem.

11. A system according to any of the claims 6-10, wh rein the means for generating a default key ratio equation is adapted for generating key ratio equations having a denominator given by the total flow input to the corresponding subsystem.

12. A system according to any of the claims 1-11, said system being adapted for displaying system-generated or user-defined key ratios.

13. A system according to any of the claims 1-12, wherein the system is adapted for attaching a tag, a variable identifier, to each node and each flow, said calculated and/or entered values of flows and stocks being displayed adjacent to the corresponding tag.

14. A system according to any of the claims 1-14, wherein the system is adapted for identifying the stock contained in each subsystem by a single-indexed tag.

15. A system according to claims 1-14, wherein the system is adapted to link each node to a dialog box allowing a user to assign the stock to be a dependent or an independent variable.

16. A system according to any of the claims 1-15, wherein the system is adapted for identifying each flow by a double-indexed tag holding information of the system or subsystem of origin of the flow and of the receiving system or subsystem.

17. A system according to claim 1-16, wherein the system is adapted to link flows to a dialog box allowing a user to assign the flow to be a dependent or independent variable.

18. A system according to claim 16 or 17 and claim 14 or 15 and any of the claims 7-14, wherein the means for generating the key ratio equations is adapted for representing flows identified by said double-indexed flow identifiers, and stocks identified by said single-indexed stock identifiers.

19. A system according to any of the claims 1-18, wherein the system is adapted to indicate for each flow the direction of the flow or resources.

20. A system according to any of the claims 1-19, wherein the system is adapted to display each node in the form of a rectangle.

21. A system according to any of the claims 1-20, wh rein the system is adapted for displaying all entered values of independent variables and all calculated values of dependent variables.

22. A system according to claim 1-21, wher in the system is adapt d to display the value of unknown independent and dependent variables as unknown to the user.

23. A system according to any of the claims 1-22, wherein the means for generating key ratio equations is adapted for generating, for each subsystem being a flow account in which the stock is an independent variable, a default key ratio equation for each outgoing flow from the subsystem minus one.

24. A system according to any of the claims 1-23, wherein the means for generating key ratio equations is adapted for generating, for each subsystem being a stock account in which the stock is a dependent variable, a default key ratio equation for each out-going flow.

25. A system according to any of the claims 5-24, wherein the means for calculating the values of the dependent variables is adapted to arrange the (n+m) linear equations in a form corresponding to a matrix equation with the values of the matrix elements being derived from the set of (n+m) linear equations and the entered values of independent variables.

26. A system according to claim 26, wherein the means for calculating the values of the dependent variables is adapted to arrange the (n+m) linear equations in a form corresponding to a matrix equation MA[i,j]*x=MB[i], where X is a solution vector comprising the dependent variables, MB[i] is a vector or matrix with a single column of independent variables, and MA[i,j] is a quadratic coefficient matrix, wherein the values of the matrix elements are derived from the set of (n+m) linear equations and wherein the elements of MB are derived from the entered values of the independent variables.

27. A system according to claim 25 or 26, wherein the means for calculating the values of the dependent variables is adapted to derive a single row of the matrix elements from a key ratio equation.

28. A system according to any of the claims 25-27, wherein the means for calculating the values of the dependent variables is adapted to derive a single row of the matrix elements from a balance equation.

29. A system according to any of the claims 25-28, wherein the means for calculating the values of the dependent variables is adapted to calculate said values by solving the matrix equation.

30. A system according to any of the claims 1-29, wherein the system further comprises a user interface for selecting either a hindcast or a forecast mode of operation, said forecast mode being operating according to a system of any of the claims 1-29.

31. A computer system for processing and display of variables representing stocks and flows of resources in a network diagram representing a balanced system, said system comprising:
a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,
a user interface for assigning for each subsystem one variable as a dependent variable, said dependent variable being either a flow of resources to or from said subsystem or the stock of resources contained in said subsystem,
means for assigning remaining flows and/or stocks of resources as independent variables,
a user interface for entering data representing values of some or all of the independent variables,
means for calculating values of some or all of the dependent variables based on the independent variables, and
means for displaying in the network diagram entered values of independent variables and calculated values of dependent variables.

32. A system according to claim 31, said system further comprising:
means for generating and/or user-defining, for each subsystem, a number of key ratio equations, each said key ratio equation being a dependent variable defined as a ratio or a fraction with a linear combination of flows and/or stocks in the numerator and another lin ar combination of flows and stocks in the denominator, said generating means being adapted for generating, for each subsystem in which th stock is assigned as an independent variable, a default key ratio definition for each outgoing flow from the subsystem minus one, and said generating means being adapted for generating, for each subsystem in which the stock is assigned as a dependent variable, a default key ratio definition for each outgoing flow.

33. A system according to claim 31 or 32, wherein said means for calculating the values of the dependent variables is adapted for generating, for each subsystem, a balance equation, said balance equation stating the balance: flows of resources into the subsystem minus flows of resources out of the subsystem equals the stock of resources contained in the subsystem.

34. A system according to claim 33, wherein said means for calculating the values of the dependent variables is adapted for calculating the values of the dependent variables based on a set of n simultaneous balance equations where n is the number of subsystems in the network.

35. A system according to any of the claims 31-34, wherein the system is adapted for attaching a tag or a variable identifier to each node and each flow, said entered values of the independent flows and/or stocks variables and the calculated values of the dependent flows and/or stocks variables being displayed adjacent to the corresponding tag.

36. A system according to any of the claims 31-35, wherein the system is adapted for identifying the stock contained in each subsystem by a single-indexed tag.

37. A system according to claim 36, wherein the system is adapted to link each node to a dialog box allowing a user to assign the stock to be a dependent or an independent variable.

38. A system according to any of the claims 31-37, wherein the system is adapted for identifying each flow by a double-indexed tag holding information of the system or subsystem of origin of the flow and of the receiving system or subsystem.

39. A system according to claim 38, wherein the system is adapted to link each flow to a dialog box allowing a user to assign the flow to be a dependent or an independent variable.

40. A system according to any of the claims 31-39, wherein the system is adapted to indicate for each flow the direction of the flow of resources.

41. A system according to claim 40, wherein the system is adapted to represent each flow by an arrow indicating the direction of the flow of resources.

42. A system according to any of the claims 31-41, wherein the system is adapted to display ach node in th form of a rectangle.

43. A system according to any of the claims 33-42, wherein the means for calculating the values of dependent variables is adapted to perform a process comprising the steps of:
a) selecting a subsystem,
b) for said selected subsystem counting the number of variables having an unknown value, and if said number is greater than one selecting a new subsystem, or, if said number equals one,
c) calculate the value of the unknown dependent variable by means of the balance equation for the selected subsystem.

44. A system according to claim 43, wherein the means for calculating the values of dependent variables is adapted to:
d) repeating steps a-c until all subsystems have been selected.

45. A system according to claim 44, wherein the means for calculating the values of dependent variables is adapted to:
e) when all subsystems have been selected according to steps a-d determining if one or more values of dependent variables have been calculated, if not, stop any further calculation of values of dependent variables, or if yes,
f) repeating steps a-d.

46. A system according to claim 45, wherein the means for calculating the values of dependent variables is adapted to:
g) repeating steps a-f until no more values of dependent variables have been calculated.

47. A system according to any of the claims 31-46, said system comprising means for generating or, by means of a user interface, for user-defining a number of key ratio equations, each said key ratio equation having a key ratio being a dependent variable set equal to a fraction or ratio with a linear combination of flows and/or stocks in the numerator and another linear combination of flows and/or stocks in the denominator.

48. A system according to any of the claims 32-47, wherein the means for generating key ratio equations is adapted to define the numerator by a single output flow from the corresponding subsystem.

49. A system according to any of the claims 32-48, wherein the means for generating key ratio equations is adapted to define the denominator by the total flow output from the corresponding subsystem plus the stock of the corresponding subsystem.

50. A system according to claim 32-48, wherein the means for generating key ratio equations is adapted to define the denominator by the total flow input to the corresponding subsystem.

51. A system according to any of the claims 38-50, wherein flows in the key ratio equations are represented by said double-indexed flow identifiers and stocks are represented by said single-indexed stock identifiers.

52. A system according to any of the claims 32-51, wherein the system is adapted to display the user-defined or system-generated key ratios.

53. A system according to any of the claims 32-52, wherein the system is adapted to calculate the numerical values of key ratios based on entered or calculated values of flows and/or stocks.

54. A system according to claim 53, wherein the system is adapted to display the calculated values of the key ratios in addition to their definition.

55. A system according to any of the claims 31-54, wherein the system is adapted to display all entered values of independent variables and all calculated values of dependent variables.

56. A system according to any of the claims 31-55, wherein the system is adapted to display each unknown variable as an unknown.

57. A system according to any of the claims 1-56, wherein the system is adapted to calculate several sets of values of dependent variables based on entered values of corresponding sets of independent variables.

58. A system according to claim 57, wherein the system is adapted to stor each said set of calculated and entered values of variables, whereby each said set can be displayed one set at a time.

59. A computer system for processing and display of variables in a user generated network diagram representing a balanced system, said variables representing stocks and flows of resources and key ratios being ratios of linear combinations of flows and/or stocks of resources, said system comprising:
a user interface for graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources to or from a subsystem,
means for assigning, for each subsystem, the variables in the form of flows of resources and stocks of resources as dependent or independent variables,
means for generating and/or user-defining, for each subsystem, a number of key ratio equations, each said key ratio equation consisting of a key ratio being a variable set equal to a fraction or a ratio with a linear combination of flows and/or stocks in the numerator and another linear combination of flows and/or stocks in the denominator, said number of key ratio equations being equal to the number of dependent variables assigned to said subsystem minus one,
a user interface for entering data representing values of some or all of the independent variables,
means for calculating values of some or all of the dependent variables based on values of independent variables, and
means for displaying entered values of independent variables and calculated values of dependent variables.

60. A system according to claim 59, wherein said means for calculating the values of the dependent variables is adapted for generating or user-defining, for each subsystem, a balance equation, said balance equation stating the balance: flows of resources into the subsystem minus flows of resources out of the system quals the stock of resources contained in the subsystem.

61. A system according to claim 59 or 60, wherein the system comprises a user interface for selecting either a hindcast or a forecast mode of operation.

62. A system according to claim 61, wherein, when the system is selected to be in the forecast mode of operation, the system comprises:
means for assigning, for each subsystem, all output flows of resources from said subsystem as dependent variables,
a user interface for assigning, for each subsystem, the stock of resources as either a dependent or an independent variable,
means for assigning all flow of resources from the giving system into a node as an independent variable, and
means for assigning all key ratios as independent variables.

63. A system according to claim 62, wherein, when the system is set to the forecast mode of operation, the system by default assigns all stocks as independent variables.

64. A system according to claim 62 or 63, said system further comprising a system selected from any of the systems of claims 4-29.

65. A system according to claim 61, wherein, when the system is set to the hindcast mode of operation, the system comprises:
means for assigning all key ratios as dependent variables, and
a user interface for assigning, for each subsystem, one variable as a dependent variable, said variable being either a flow of resources or the stock of resources of said subsystem, and
means for assigning flows and/or stocks of resources as independent variables.

66. A system according to claim 65, said syst m further comprising a system selected from any of the systems of claims 34-58.

67. A computer implemented method for processing and display of variables in a user generated network diagram representing a balanced system, said variables representing stocks and flows of resources and key ratios being ratios of linear combinations of flows and/or stocks of resources, said method comprising:
graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,
for each subsystem assigning all output flows of resources from said subsystem as dependent variables,
for each subsystem assigning the stock of resources as a dependent or an independent variable,
assigning all flows of resources from the giving system into a node as an independent variable,
for each subsystem generating and/or user-defining a number of key ratio equations, each said key ratio equation consisting of a key ratio being an independent variable set equal to a fraction or a ratio with a linear combination of flows and/or stocks in the numerator and another linear combination of flows and/or stocks in the denominator, said number of key ratio equations being equal to the number of dependent variables assigned to said subsystem minus one,
entering and storing data representing values of some or all of the independent variables, and
calculating values of some or all of the dependent variables based on values of independent variables.

68. A m thod according to claim 67, said method further comprising displaying entered values of independent variables and calculated values of dependent variables.

69. A method according to claim 67 or 68, wherein each subsystem has a corresponding balance equation, said balance equation stating the balance: flows of resources into the subsystem minus flows of resources out of the subsystem equals the stock of resources contained in the subsystem.

70. A method according to claim 69, wherein the calculation of the values of the dependent variables is based on the balance equations and the key ratio equations.

71. A method according to claim 70, wherein the calculation of the values of the dependent variables is based on a set of n+m simultaneous linear equations where n is equal to the number of subsystems in the network, and thereby to the number of balance equations, and m is equal to the sum of the minimum required number of key ratio equations for each subsystem.

72. A method according to any of the claims 67-71, wherein some or all of the key ratio equations are default or system-generated key ratio equations.

73. A method according to any of the claims 67-72, wherein some or all of the key ratio equations are user-defined key ratio equations.

74. A method according to any of the claims 67-73, wherein a key ratio equation has a numerator given by a single output flow from the corresponding subsystem.

75. A method according to any of the claims 67-74, wherein a default key ratio equation has a denominator given by the total flow output from the corresponding subsystem plus the stock of the corresponding subsystem.

76. A method according to any of the claims 67-74, wherein a default key ratio equation has a denominator given by the total flow input to the corresponding subsystem.

77. A method according to any of the claims 67-76, wherein the system-generated or user-defined key ratio equations are identified and displayed.

78. A method according to any of the claims 67-77, wherein entered values of key ratios are displayed.

79. A method according to any of the claims 67-78, wherein a tag or a variable identifier is attached to each node and each flow, said calculated and/or entered values of flows and/or stocks being displayed adjacent to the corresponding tag.

80. A method according to any of the claims 67-79, wherein for each subsystem the stock is identified by a single-indexed tag.

81. A method according to claim 67-80, wherein each node is linked to a dialog box allowing a user to assign the stock to be a dependent or an independent variable.

82. A method according to any of the claims 67-81, wherein each flow is identified by a double-indexed tag referring to the system or subsystem of origin of the flow and of the receiving system or subsystem.

83. A method according to claim 67-82, wherein each flow is linked to a dialog box allowing a user to assign the flow to be a dependent or an independent variable.

84. A method according to claim 82 or 83, wherein flows in the key ratio equations are represented by said double-indexed flow identifiers and stocks are represented by said single-indexed stock identifiers.

85. A method according to any of the claims 6784, wherein each flow indicates the direction of the flow or resources.

86. A method according to claim 85, wherein each flow is represented by an arrow showing the direction of the flow of resources.

87. A method according to any of the claims 67-86, wherein each node has the form of a rectangle.

88. A method according to any of the claims 67-87, wherein all entered values of independent variables and all calculated values of dependent variables are displayed.

89. A method according to claim 67-88, wherein unknown independent and dependent variables have their value displayed as an unknown.

90. A method according to any of the claims 67-89, wherein the network comprises one or more subsystems being flow accounts having the stock assigned as an independent variable.

91. A method according to any of the claims 67-89, wherein the network comprises one or more subsystems being stock accounts having the stock assigned as a de pendent variable.

92. A method according to claim 91, wherein the network comprises at least one subsystem being a flow account and at least one subsystem being a stock account.

93. A method according to claim 90, wherein all subsystems are flow accounts.

94. A method according to any of the claims 90-93, wherein for each subsystem being a flow account, a key ratio equation is set up for each outgoing flow from the subsystem minus one.

95. A method according to any of the claims 91, 92 or 94, wherein for each subsystem being a stock account, a key ratio equation is set up for each outgoing flow.

96. A method according to any of the claims 71-95, wherein the values of the dependent variables in the form of output flows and/or stocks are calculated as functions of the independent variables in the form of key ratios, input flow(s) from the giving system, and/or stock(s) of subsystems.

97. A method according to any of the claims 71-96, wherein the (n+m) linear equations are arranged in a form corresponding to a matrix equation with the values of the matrix elements being derived from the set of (n+m) linear equations and the entered values of independent variables.

98. A method according to any of the claims 71-97, wherein the (n+m) linear equations are arranged in a form of a matrix equation MA[i,j]*X=MB[i], where X is a solution vector comprising the dependent variables, MB[i] is a vector or matrix with a single column based on independent variables, and MA[i,j] is a quadratic coefficient matrix, wherein the values of the matrix elements of MA and MB are derived from the set of (n+m) linear equations and the entered values of independent variables.

99. A method according to claim 97 or 98, wherein each key ratio equation is represented by a single row in the matrix equation.

100. A method according to any of the claims 97-99, wherein each balance equation is repr sented by a single row in the matrix equation.

101. A method according to any of the claims 97-100, wherein the matrix equation is solved and the calculated values of dependent variables are displayed.

102. A computer implemented method for processing and display of variables representing stocks and flows of resources in a network diagram representing a balanced system, said method comprising:
graphically creating a balanced system depicted by a network diagram having one or more nodes, at least one input flow from a giving system into a node, at least one output flow from a node into a receiving system, and/or one or more flows between nodes, said giving and receiving systems being systems outside the balanced system, each node representing a subsystem with a stock of resources and each flow representing a flow of resources,
for each subsystem assigning one variable as a dependent variable, said dependent variable being either a flow of resources to or from said subsystem or the stock of resources contained in said subsystem, the remaining variables of stocks and flows being independent,
entering and storing data representing values of some or all of the independent variables, calculating values of some or all of the dependent variables based on the independent variables, and
displaying in the network diagram entered values of independent variables and calculated values of dependent variables.

103. A method according to claim 102, wherein each subsystem has a corresponding balance equation, said balance equation giving a balance between flows of resources to and from the subsystem and the stock of resources of the subsystem.

104. A method according to claim 103, wherein the calculation of the values of the dependent variables is based on a set of n simultaneous balance equations where n is the number of subsystems in the network.

105. A method according to any of the claims 102-104, wherein a tag or a variable identifier is attached to each node and each flow, said ntered data representing values of the independent variables being displayed adjacent to the corresponding tag.

106. A method according to claim 105, said calculated values of the dependent variables and the entered values of the independent variables being displayed adjacent to the corresponding tag.

107. A method according to any of the claims 102-106, wherein for each subsystem the stock contained in the subsystem is identified by a single-indexed tag.

108. A method according to claim 107, wherein each node is linked to a dialog box allowing a user to assign the stock to be a dependent or an independent variable.

109. A method according to any of the claims 102-108, wherein each flow is identi fied by a double-indexed tag referring to the system or subsystem of origin of the flow and to the receiving system or subsystem.

110. A method according to claim 109, wherein each flow is linked to a dialog box allowing a user to assign the flow to be a dependent or an independent variable.

111. A method according to any of the claims 102-110, wherein each flow indicates the direction of the flow of resources.

112. A method according to claim 111, wherein each flow is represented by an arrow indicating the direction of the flow of resources.

113. A method according to any of the claims 102-112, wherein each node has the form of a rectangle.

114. A method according to any of the claims 103-113, wherein the process of calculating the values of the dependent variables comprises:
a) selecting a subsystem,
b) for said selected subsystem counting the number of variables having an unknown value, and if said number is greater than one selecting a new subsystem, or, if said number equals one,
c) calculate the value of the unknown dependent variable by means of the balance equation for the selected subsystem.

115. A method according to claim 114, wherein the process of calculating the values of the dependent variables further comprises:
d) repeating steps a-c until all subsystems have been selected.

116. A method according to claim 115, wherein the process of calculating the values of the dependent variables further comprises:
e) when all subsystems have been selected according to steps a-d determining if one or more values of dependent variables have been calculated, if not, stop any further calculation of values of dependent variables, or if yes,
f) repeating steps a-d.

117. A method according to claim 116, wherein the process of calculating the values of the dependent variables further comprises:
g) repeating steps a-f until no more values of dependent variables have been calculated.

118. A method according to any of the claims 102-117, wherein for each subsystem a number of key ratio equations are generated and/or defined, each said key ratio equation having a dependent variable in the form of a key ratio set equal to a ratio or a fraction with a linear combination of flow and/or stocks in the numerator and another linear combination of flows and stocks in the denominator, where for each subsystem in which the stock is assigned as an independent variable a default key ratio equation is generated for each out-going flow from the subsystem minus one, and for each subsystem in which the stock is assigned as a dependent variable a default key ratio equation is generated for each outgoing flow.

119. A method according to claim 118, wherein one or more key ratio equations are defined by a user.

120. A method according to claim 118 or 119, wherein a subsystem has one or more corresponding key ratio equations, and a key ratio has a numerator defined by a single output flow from the corresponding subsystem.

121. A method according to any of the claims 118-120, wherein a key ratio has a denominator given by the total flow output from the corresponding subsystem plus the stock of the corresponding subsystem.

122. A method according to any of the claims 118-120, wherein a key ratio has a denominator given by the total flow input to the corresponding subsystem plus.

123. A method according to any of the claims 118-122 and any of the claims 109-117, wherein flows in the key ratio equations are represented by said double-indexed flow identifi rs and stocks are represented by said single-indexed stock identifiers.

124. A method according to any of the claims 118-123, wherein the key ratio equations are displayed.

125. A method according to any of the claims 118-124, wherein some or all of the key ratio equations are calculated based on entered or calculated values of flows and/or stocks.

126. A method according to claim 125, wherein a key ratio is calculated when all the values of flows and/or stocks corresponding to the definition given by the key ratio equation have been entered or calculated.

127. A method according to claim 125 or 126, wherein the calculated values of the key ratios are displayed.

128. A method according to any of the claims 102-127, wherein all entered values of independent variables and all calculated values of dependent variables are displayed in the network diagram.

129. A method according to claim 102-128, wherein unknown independent and dependent variables have their value displayed as an unknown.

130. A method according to any of the claims 102-129, wherein the network-comprises a subsystem being a flow account having one flow assigned as a dependent variable, the remaining flows and the stock of said subsystem being independent variables.

131. A method according to any of the claims 102-130, wherein the network comprises a subsystem being a stock account having the stock assigned as a dependent variable able and all flows of said subsystem being independent variables.

132. A method according to claim 131, wherein the network comprises at least one subsystem being a flow account and at least one subsystem being a stock account.

133. A method according to claim 132, wherein all subsystems are flow accounts.

134. A method according to any of the claims 130-133, wherein for each subsystem being a flow account, a key ratio equation is set up for each outgoing flow from the subsystem minus one.

135. A method according to any of the claims 130-132 or 134, wherein for each subsystem being a stock account, a key ratio equation is set up for each outgoing flow.

136. A method according to any of the claims 102-135, wherein several sets of values of dependent variables are calculated based on entered values of corresponding sets of independent variables.

137. A method according to claim 136, wherein each said set of calculated and entered values of variables are stored, whereby each said set can be displayed one set at a time.

138. A method according to any of the claims 102-137, wherein a resource is selected from a group of resources comprising: money, energy, and materials.

139. A computer program comprising computer program code means for adapting a computer to a system selected from the systems of claims 1-29 when said program is installed on the computer.

140. A computer program as claimed in claim 139 embodied on a computer-readable medium.

141. A computer program comprising computer program code means for adapting a computer to a system selected from the systems of claims 31-58 when said program is installed on the computer.

142. A computer program as claimed in claim 141 embodied on a computer-readable medium.

143. A computer program comprising computer program code means for adapting a computer to a system selected from the systems of claims 59-66 when said program is installed on the computer.

144. A computer program as claimed in claim 143 mbodied on a computer-readable medium.
